(19) United States
(12) Patent Application Publication
(10) Pub. No.: US 2007/0016650 A1
(43) Pub. Date: Jan. 18, 2007

(54) System and methods for collaborative development of content over an electronic network

(76) Inventors: Gary James Gilbert, Bedford, NH (US); Byron Lennard Fuller, Mesa, AZ (US); David Young, Tempe, AZ (US); Rodney James Hing, Phoenix, AZ (US); Mike Sanders, Gilbert, AZ (US); Sherman Mohler, Gilbert, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/395,052

(22) Filed: Mar. 31, 2006

Related U.S. Application Data
(60) Provisional application No. 60/667,838, filed on Apr. 1, 2005.

(51) Int. Cl. G06F 15/16; G06F 17/00

(52) U.S. Cl. 709/207; 715/751

(57) ABSTRACT

Systems and methods for collaborative authorship of content for a distributed delivery system are provided. The system comprises a server configured to store and regulate access to one or more course materials developed by one or more authors, wherein the one or more course materials comprise information to be taught to a student. The system further comprises one or more client computer systems configured to communicate with said server, each of the one or more client computer systems comprising a display configured to show a hierarchy of course materials, a messaging module configured to send and receive content-related event messages to and from the server, and a user interface module configured to update the display in accordance with content-related events. The server is configured to send event messages to the one or more client computer systems. In some embodiments, the one or more client computer systems are configured to synchronize content with the server.

### RELATED APPLICATIONS

The present application claims priority to U.S. Provisional Application No. 60/667,838, filed Apr. 1, 2005, the disclosure of which is incorporated by reference herein. This application also incorporates by reference the full disclosures of U.S. Patent Publication No. 2002/0138841 to Ward, published on Sep. 26, 2002, entitled, “System For Distributed Learning;” and U.S. Patent Publication No. 2005/0287509 to Mohler, published on Dec. 29, 2005, entitled “Learning Objects in an Electronic Teaching System.”

### BACKGROUND OF THE INVENTION

1. Field of the Invention

The present invention relates generally to content development and delivery systems and specifically to systems and methods facilitating collaborative authorship of educational content for online learning programs.

2. Description of the Related Art

With the evolution of the Internet, teaching students through online teaching systems has become more popular. These online teachings systems provide electronic versions of curriculums, and tests to assess how well the students have mastered the information. These systems thereby provide the teacher with additional tools for teaching students to learn a particular subject matter.

U.S. Patent Publication No. 2002/013884 to Ward discloses a system for distributed learning that allows authors to jointly prepare educational content for students by collaborating over a network, such as the Internet.

### SUMMARY OF THE INVENTION

In one aspect of the invention, a system for authoring content for a distributed learning system is provided. The system comprises one or more servers configured to store an educational course configured to be delivered electronically to students. The course has been developed by a plurality of authors. The system also comprises a synchronization module configured to detect a change in the course. Responsive to said change, the synchronization module is configured to send messages to the authors informing them of the change.

In another aspect of the invention, a method for synchronizing content in a distributed learning system is provided. The method comprises electronically storing within a storage an educational course that has been authored by a plurality of authors. The course is configured to be delivered electronically to students. The method further comprises determining that a change has occurred to the educational course, and, responsive to said determination, electronically informing one or more of the authors of the change.

In yet another aspect of the invention, a system for synchronizing content in a distributed learning system is provided. The system comprises a means for storing an educational course configured to be delivered electronically to students, the course having been developed by a plurality of authors. The system further comprises a means for detecting a change in the educational course and a means for informing at least one of said authors of the change.

In still another aspect of the invention, an authoring system for an educational course is provided. The course is configured to be delivered electronically to students. The course comprises a plurality of content objects organized in accordance with a content object hierarchy. The authoring system comprises a rules module employing a set of format rules governing presentation of the content objects within the content hierarchy. The rules module is configured to (1) analyze the content objects for violations of the format rules as the content objects are being created by an author, and (2) if one of the format rules is violated, inform the author of the rule violation.

In still another aspect of the invention, a method of controlling an educational course is provided. The course is configured to be delivered electronically to students. The course comprises a plurality of content objects organized in accordance with a content object hierarchy. The method comprises analyzing content objects for violations of format rules as the content objects are being created by an author, the format rules governing presentation of the content objects within the content object hierarchy. The method further comprises detecting a violation of at least one of the format rules and informing the author about the rule violation.

In still another aspect of the invention, a system for collaborative authorship of content for a distributed delivery system is provided. The system comprises at least one server configured to store an educational course configured to be delivered electronically to students. The course comprises a plurality of content objects organized in accordance with a content object hierarchy, the course having been developed by a plurality of authors. The system also comprises a plurality of client computer systems configured to communicate with the server. Each of the client computer systems comprises a display configured to show a hierarchical outline of the educational course, a messaging module configured to send and receive course-related event messages to and from the server, and a user interface module configured to update the display in accordance with course-related events. The server is configured to send course-related event messages to the client computer systems.

In still another aspect of the invention, a method of regulating access to an educational course is provided. The method comprises maintaining in storage an educational course configured to be delivered electronically to students. The course comprises a plurality of content objects organized in accordance with a content object hierarchy, the course having been developed by a plurality of authors. The method further comprises receiving a request from a first author to check out a content object, and notifying at least one other author that the content object has been checked out by the first author.

In still another aspect of the invention, a method of modifying educational course material while disconnected from a distributed learning system is provided. The method comprises connecting a client computer to a storage, the storage maintaining an educational course configured to be delivered electronically to students, the course comprising a plurality of content objects organized in accordance with a content object hierarchy, the course having been developed by a plurality of authors. The method further comprises checking out a content object from the storage, disconnecting the client computer from the storage after checking out the content object, modifying the content object on the client computer while the client computer is disconnected from the storage, and reconnecting the client computer to the storage after modifying the content object.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a block diagram of a system for collaborative authorship of educational content for online learning, according to aspects of an embodiment of the invention.

FIG. 2 is a flow chart of a process in which the system automatically synchronizes a project of course materials in response to a user checking out the project from the server.

FIG. 3 is a flow chart of a process in which the system automatically synchronizes an object and its child objects.

FIG. 4 is a flow chart of a process in which a user selectively synchronizes content.

FIG. 5 is a flow chart of a process in which a user synchronizes content based only upon the differences between the server and client versions of the content.

FIG. 6 is a flow chart of a process in which the system informs a user that an object in use is not current, and the user synchronizes the object to obtain the most recent version.

FIG. 7 is a flow chart of a process in which a user becomes informed of and synchronizes a new top-level object.

FIG. 8 is a flow chart of a process in which the system informs a user that an object in use has been checked-out by another client during the user's session.

FIG. 9 is a flow chart of a process in which the system informs a user that an object has been deleted by another client during the user's session.

FIG. 10 is a flow chart of a process in which a user updates a “reference” in a given course material.

FIG. 11 is a pair of flow charts illustrating how a user can update a reference to a deleted object.

FIG. 12 is a pair of flow charts illustrating how a user can update a link to a deleted object.

FIG. 13 is a flow chart of a process in which the system provides updates of the current status of objects.

FIG. 14 is a flow chart illustrating a process in which the system updates a client's status indicators when an object becomes checked into the server (from someone else) during the user's session.

FIG. 15 is a flow chart of a process in which the system updates a client's status indicators when an object becomes checked-out of the server (by someone else) during the user's session.

FIG. 16 is a flow chart of a process in which a user modifies a content object while disconnected from a server.

FIG. 17 is a database model according to one embodiment of the invention.

FIGS. 18-24 are screenshots of a client display during use of the system of the invention, in accordance with one embodiment of the invention.

### DETAILED DESCRIPTION

Certain embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein. While illustrated in the context of an online learning program, it will be understood that the invention can be used in other contexts.

One embodiment of the invention relates to an online teaching and authoring system that allows authors to collaborate as they develop content. In one embodiment, the learning content learning management system (LCMS), herein referred to as “the system,” includes a server that stores content from multiple authors and includes a synchronization module that detects changes in content items developed by authors. If a change in content items is detected, the system sends a message to other authors notifying them of the changed content.

Another embodiment of the invention relates to a method by which the system permits authors (also referred to herein as “users”) to “synchronize” with (i.e., obtain the most current version of) one or more changed course materials (e.g., content items). In one option, the author can synchronize with respect to specifically selected course materials. In another option, the author can simply implement a “diff” procedure whereby the system detects and synchronizes with respect to all of the differences between an author's locally stored version of specific course materials and the version stored on the server. For example, if the author has a specific course chapter stored locally, the author can implement a diff procedure for the chapter, as opposed to the entire course. The system can be configured to synchronize all content of a project with an author's client when the client accesses the project for the first time. In some implementations, the system stores successively edited versions of course materials and permits an author to “roll-back” to a previous version of a course material.

In a preferred embodiment, the system prevents authors from checking-out course material that is currently checked-out by another author, to prevent simultaneous editing of the same material. The system also preferably prevents authors from checking out “child objects” of a checked-out course material (i.e., objects or materials that are below the checked-out course item in a hierarchical course organizational structure). The system preferably enables authors to check-out a “sibling” course material of a checked-out course material (i.e., a course material that is at the same hierarchical level as the checked-out course material), but prevents authors from checking-out “parent” course materials of the checked-out course material. Still another embodiment of the invention relates to a method by which the system informs authors of the deletion of course material by another author, and allows authors to synchronize with the revised course or portion thereof containing the deletion.

In preferred embodiments, the system allows authors of course materials to insert other authors' materials therein. In one option, a first author can insert a “reference” to a second author's material. In this option, when the content delivery engine renders the first author's course material to a student, it inserts a read-only copy of the second author's material. In another option, the first author can insert a “link” to the second author's material, which is akin to an Internet hyperlink. Still another embodiment of the invention relates to a method by which the system informs authors of instances in which referenced or linked-to material has been deleted (a “broken reference” or “broken link”), and allows authors to synchronize content to correct the broken reference or link. In another aspect, the system can permit an author to obtain an editable version (or “repurpose”) of a course material.

Distributed Learning System

Embodiments of the present invention relate to a distributed learning system. The learning system allows for the dynamic creation of teaching materials personally tailored for the needs of the individual striving to learn the course material.

The system allows for courses to be designed and presented to students over a network, such as the Internet. Each course is composed from a set of learning objectives aimed at teaching the student a certain desired set of skills. One learning objective (LO), for example, might be to learn how to program a computer. This is an example of a very broad learning objective. Accordingly, each learning objective may include a defined set of target indicators (TI's). For example, the LO could be Visual Basic knowledge and the TI's might include command instructions in Visual Basic or display techniques of Visual Basic. Accordingly, each TI could include an indicator that the student has learned the learning objective. The overall course could be called “How to Program a Computer”.

In order to teach a student a TI, a series of content items (Cl's) and content sections (CS's) can be provided. Each content item includes information that relates to its TI. For example, if the TI is Visual Basic knowledge, related content items might include text pages showing Visual Basic commands. Each page displays one or more content items. Preferably, content items can include child content items and content sections, and a content item or content section can serve a parent content item or content section. Alternatively, a set of related commands might also be a single content item. In addition, content items can be image files, video files, text files and/or sound files that provide information for the particular target indicator. That is, a content item may include a plurality of content items and content sections.

Associated with the content items are one or more assessment items (AI's), which are typically examination questions that test the student's knowledge of the content item. For example, if the content item includes text that teaches how to use the command “PRINT” from Visual Basic, the assessment item might include a question such as “What command is used to print to the printer?” This allows assessment of the student's knowledge of the content item (or plurality of content items). Such a test would not necessarily have to be in written form, but could be performed through image, video, and/or sound files. Because of the relationship between content items and assessment items, the system can provide a very granular analysis of what a particular student has learned. By providing a set of assessment items that test for knowledge of particular content items, instructions within the system can determine which content items have been learned by the student, and which content items are not known. Assessment items can be tied at the LO, TI, or CI level, in order to properly associate the item with the right granularity of objectives.

Once a determination is made of the content items that need to be learned, the system can provide varying types of content items (or personalized feedback) to teach the student. For example, if the student cannot answer the question “What command is used to print to the printer?”, the system can then display additional Visual Basic command text, play a video, or play a sound file that instructs the student on the use of the command “PRINT”.

As discussed below, a student can access the course through a computer system. In one embodiment, the course is presented within a browser software program such as Internet Explorer from Microsoft Corporation, or Netscape Navigator from Netscape Corporation. Once the student has requested the course, the course is presented to the student through the browser software executing on the student's computer system.

Embodiments of the system are configured to monitor and determine the student's learning preference as the student proceeds in the course and interacts with the curriculum. The system also is capable of testing the student to determine which portions of the curriculum the student has understood. Thus, the system is able to determine the student's progress in the course and the student's comprehension of the contents of the course.

If the system determines through testing that a student has not fully comprehended some aspect of the coursework, the system may provide additional information on the unlearned portions of the course. This additional information can be placed within a subsequent supplementary course to be presented to the student, or be part of the same curriculum. Moreover, the system can provide the supplementary information in a format most useful to the student. For example, if the student has been found to learn most effectively through visual teaching, a video on demand (VOD) can be presented to the student. Conversely, if the student has been found to learn most effectively through reading, the system can present the student with written information.

The learning system described herein also can utilize an external cache system for delivering content to the students through its Caching Application Programming Interface (API). In one embodiment, the Caching API interfaces with a controlled replication and content routing system, such as the Self-Organizing Distributed Architecture (SODA) developed by SitePath, Inc. (Waltham, Mass.). Of course, the Caching API is not limited to interface with only a specific type of caching scheme. Other schemes, such as the Digital Island system disclosed in U.S. Pat. No. 6,185,598, issued on Feb. 6, 2001, which is hereby incorporated by reference in its entirety, could also be used.

For example, a course delivery engine that stores the coursework to be presented is maintained centrally. However, copies of the course contents are transmitted and maintained at a location local to the student's computer system. For instance, a copy of the curriculum might be maintained on the student's local area network (LAN). However, because the system described herein is capable of connecting together many sites throughout the world, copies of the curriculum can be stored, for example, within a server in each country and within a server for each region of the world. By keeping copies of the course contents distributed onto multiple servers that are near the student's sites, the system is capable of delivering content to the student more efficiently.

Providing this caching mechanism allows an embodiment of the system to incorporate instructions for tracking when curriculum has been updated on the central server. Once a particular curriculum file is updated, a new copy of the updated curriculum is sent to each of the remotely cached sites so that the students may be provided with the most up-to-date information.

Definitions

1. Application Programming Interface (API)

An API is a set of routines, protocols, and tools for building software applications. An API facilitates the development of software programs or systems by providing the building blocks that may be utilized in building a software program or system. A programmer can then access and use the API to create or modify a software program or system.

2. Assessment Items

Assessment items are queries that may be posed to the student to indicate the student's comprehension of the course material. The assessment items can be content-related questions, such as, for example, true or false questions, multiple choice questions, fill-in-the-blank questions, point and click questions, drag-and-drop questions, free text questions, and the like.

3. Content Items

Content items refer to the presentation of educational material, including any tools that can deliver or contain educational content. Content items can be in many forms, such as, for example, image files, video files, sound files, Microsoft Word documents, Microsoft PowerPoint presentations, Flash animations, streaming video, collaborative work environments, or any tool that can deliver educational content. Content items can contain one or more content items (CIs) and content sections (CSs), which are metadata tagged to reflect instructional design (e.g., learning styles or instructional strategies). One example of a section instructional design is a questions and answers (Q&A) format. Another example of a section instructional design is a computer-implemented guide or advisor (e.g., “guru”) to facilitate a student's learning experience. Content items can map to target indicators, which can in turn map to learning objectives.

4. Course

A course is a collection of learning objectives, TIs, CIs and CSs aimed at teaching a certain curriculum to a student. A course can be designed and presented to students over a network, such as the Internet. Each course may be composed of one or more learning objectives. A “course material” broadly refers to a course or a portion of a course.

5. Input Devices

Input devices are capable of transmitting information from a user to a computer, for example, a keyboard, rollerball, mouse, voice recognition system or other device. The input device may also be a touch screen associated with the display, in which case the user responds to prompts on the display by touching the screen. The user may enter textual information through the input device such as the keyboard or the touch-screen.

6. Instructions

Instructions refer to computer-implemented steps for processing information in the system. Instructions can be implemented in software, firmware or hardware and can include any type of programmed step undertaken by components of the system.

7. Local Area Network (LAN)

One example of the Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

8. Learning Objectives

Learning objectives refer to major topics, i.e. educational goals, which are typically not easily assessable. The learning objectives may include broad concepts, such as, for example, “Understanding the Use of a Web Browser”. A learning objective typically is separated into smaller conceptual units (target indicators) which can be more easily taught and tested. A learning objective is generally generated by a job task or skills analysis. One or more learning objectives normally form a complete course.

9. Media

Media refers to images, sounds, video or any other multimedia type data that is entered into the system.

10. Microprocessor

The microprocessor may be any conventional general purpose single- or multi-chip microprocessor, such as a Pentium® processor, a Pentium® Pro processor, a 8051 processor, a MIPS® processor, a Power PC® processor, an ALPHA® processor, or other general purpose microprocessor, including those yet to be developed. In addition, the microprocessor may be any conventional special purpose microprocessor, such as a digital signal processor or a graphics processor. The microprocessor typically has conventional address lines, conventional data lines, and one or more conventional control lines.

11. Modules

A system is comprised of various modules as discussed in detail below. As can be appreciated by one of ordinary skill in the art, each of the modules may comprise various sub-routines, procedures, definitional statements and macros. Each of the modules are typically separately compiled and linked into a single executable program. Therefore, a description of each of the modules is used for convenience to describe the functionality of certain embodiments of the system. Thus, the processes that are undergone by each of the modules may be arbitrarily redistributed to one of the other modules, combined together in a single module, or made available in, for example, a shareable dynamic link library. Note that the single word “module” is not to be confused with “content module,” which refers to educational content suitable for presentation to a user on a computer display.

12. Networks

The system may include any type of electronically connected group of computing systems, including, for example, one or more of the networks from the following non-exhaustive list: Internet, Intranet, Local Area Networks (LAN) or Wide Area Networks (WAN). In addition, the connectivity to the network may be, for example, by way of remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, wireless, set-top, or any other desired type of configuration. As used herein, an Internet includes network variations such as public Internet, a private Internet, a secure Internet, a private network, a public network, a value-added network, an Intranet, and the like. In other words, as used herein, the term network refers to any type of connectivity between computing devices for the transfer of data.

13. Operating Systems

The system may be used in connection with various operating systems, such as those from the following non-exhaustive list: UNIX, Disk Operating System (DOS), OS/2, Windows 3.X, Windows 95, Windows 98, Windows NT, including other operating systems yet to be developed. New operating systems and revisions of existing operating systems are continually being developed, and these are also within the scope of the present invention.

14. Programming Languages

The system may be written in any programming language such as C, C++, BASIC, Pascal, Java, and FORTRAN, and executed under one or more of the many well-known operating systems. C, C++, BASIC, Pascal, Java, and FORTRAN are industry standard programming languages for which many commercial compilers can be used to create executable code.

15. Target Indicators

Target indicators are assessable educational sub-topics that are portions of the broader learning objective. Each learning objective may be composed of one or more target indicators.

16. Transmission Control Protocol

Transmission Control Protocol (TCP) is a transport layer protocol used to provide a reliable, connection-oriented, transport layer link among computer systems. The network layer provides services to the transport layer. Using a two-way handshaking scheme, TCP provides the mechanism for establishing, maintaining, and terminating logical connections among computer systems. TCP transport layer uses Internet Protocol (IP) as its network layer protocol. Additionally, TCP provides protocol ports to distinguish multiple programs executing on a single device by including the destination and source port number with each message. TCP performs functions such as transmission of byte streams, data flow definitions, data acknowledgments, lost or corrupt data re-transmissions and multiplexing multiple connections through a single network connection. Finally, TCP is responsible for encapsulating information into a datagram structure.

17. Web Browser

A web browser is a software or hardware device capable of displaying graphical and/or textual information from a web page on a computing device. For example, popular web browsers presently include those commercially available from companies such as Netscape, Microsoft Corporation, Mozilla and the like.

18. Object

An “object” (or “content object”) refers to a course material, such as an entire course or course portion. An object is preferably part of a hierarchy of objects. An object may be subservient to other objects in a hierarchy (i.e., an object may have a parent object). An object may have objects that serve it in the hierarchy (i.e., an object may have child objects). Additionally, multiple objects may be associated with the same parent object. Objects directly underneath the same parent object are herein referred to as “siblings.” As one example, an object may be a content item. As another example, an object may be a course selected from a plurality of courses within a particular project. In such a case, the course may contain one or more LO's, TI's, CI's and CS's.

Synchronization and Object Status Indicators

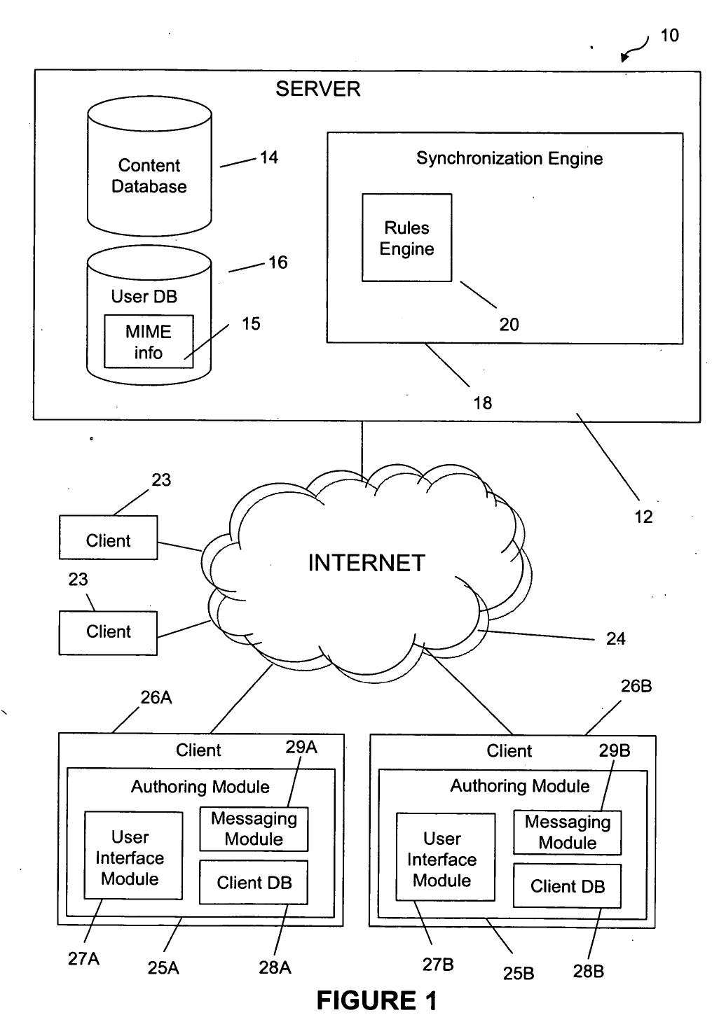

FIG. 1 shows a block diagram of a learning content management system (LCMS) 10 for online learning and collaborative authorship of educational content. The system 10 includes one or more computer servers 12 that include a content database 14, a user database 16, and a synchronization engine 18. The content database 14 contains educational content available for download by students for online learning. The database 14 also includes educational content that is currently being prepared, revised, updated, etc. by one or more authors. The user database 16 contains information about the various users of the system 10, including authors, organizational administrators and super administrators. Organizational administrators manage content used by organizations (e.g., schools, companies, etc.), and super administrators manage content from the server level. The information in the user database 16 is used to manage user logins to the server 12, as well as other administrative tasks. The synchronization engine 18 includes a rules engine 20, which is described below. The server 12 is connected via a network 24 (such as the Internet) to a plurality of client computer systems (hereinafter “clients”) 23 and 26, which users may use to access and use the system 10. The clients 23 and 26 may comprise computers with appropriate software, hardware, or firmware for accessing the server 12 and using the system 10.

In a preferred embodiment, the clients 26 include authoring modules 25 for authoring, creating and modifying the content stored in the content database 14. FIG. 1 shows two authoring clients 26A and 26B. However, skilled artisans will appreciate that the system 10 can include any number of authoring clients 26. Each authoring module 25 preferably includes a user interface module 27 and a messaging module 29. In the illustrated embodiment, the client 26A comprises an authoring module 25A that includes a user interface module 27A and a messaging module 29A. Likewise, the client 26B comprises an authoring module 25B that includes a user interface module 27B and a messaging module 29B. In contrast to the clients 26, the clients 23 may be more appropriate for use by students who wish to access the content from the content database 14 and who are not involved in authoring the content.

The authoring module 25 is preferably configured to perform multithreaded tasks, including (1) receiving an author's content-related inputs (e.g., add new content, modify content, download content, upload content, etc.), (2) receiving and processing event messages from the server 12 concerning the activities of other authors, and (3) updating the client display to reflect the activities of the author and other authors using the system 10. The user interface module 27 is preferably configured to receive the author's content-related inputs and to display in real-time the activities of the author and other authors using the system 10. The messaging module 29 is preferably configured to receive and process the event messages received from the server 12.

For example, suppose an Author A using client 26A “checks-out” and begins working on a particular content item or course material (e.g., a chapter of a course) from the server 12. The checked-out content item is a portion of a larger group of content items (“content”) stored in the content database 14. At a granular level, the content comprises a plurality of objects having a hierarchical structure. The user interface module 27A is configured to update the client's display to show the object hierarchy of the content with a visual indication of the checked-out content item. Upon checking out the content item to client 26A, the server 12 sends event messages to all of the other clients 26 (or perhaps to only a set of clients 26 that are known to have an interest in the particular checked-out content item or the content portion that contains the checked-out content item), including client 26B, indicating that the content item has been checked-out (possibly with an indication that Author A checked it out). In some embodiments, the event messages are sent to all of the other clients 26 substantially simultaneously. The event message is received and appropriately processed by the messaging module 29B. An exemplary messaging platform is Java Message Services (JMS). The user interface module 27B then updates the display of client 26B to show that the particular content item has been checked out. Thus, an Author B using client 26B will learn in real-time that the particular content item has been checked-out. It will be understood that the user interface module 27B can inform Author B about the checked-out content item in a variety of different ways, such as by a pop-up window message, an email message, etc. In a preferred embodiment, the user interface module 27B updates the display of client 26B to visually differentiate the checked-out content item within the object hierarchy.

With continued reference to FIG. 1, each client 26 (such as the clients 26A and 26B) includes a client database 28 (such as the illustrated databases 28A and 28B) for storing content objects. The client databases 28A and 28B permit authors to work on particular course or course portions off-line (i.e., without network connection to the system 10). In some embodiments, the client databases 28A and 28B contain all of the material associated with a particular project, and all changes made to that project are made on the client. From the author's perspective, this improves performance because responsiveness is not limited by the transfer of data between the client 26 and the server 12. Data transfer over the network 24 is limited to particular events, such as, e.g., synchronization events and event messages.

In another example, suppose Author A creates a new object or new content directory within the hierarchy. The user interface module 27A preferably updates the object hierarchy on the display of client 26A to show the new object or new content directory. The messaging module 29A then preferably sends metadata to the server 12 to indicate the existence of the new object or new content directory. At this stage in the process, the new object or directory has not been uploaded to the server 12. However, once the object or directory is uploaded to the server, the server 12 is configured to immediately send event messages (e.g., via JMS) to the other clients 26, including the client 26B, to indicate the creation of the new object/directory. In an alternative embodiment, the server 12 is configured to send event messages to the other client 26, including the client 26B, before the new object/directory is uploaded to the server. Thus, the messaging module 29B receives and appropriately processes the event message, and the user interface module 27B renders a message on the display of client 26B to indicate the creation of the new object/directory (and possibly an indication that Author A is the creator). In a preferred embodiment, the user interface module 27B refreshes the computer screen of client 26B to show the object hierarchy with a visual indication of the new object/directory.

It will be appreciated that the authoring clients 26 can be configured to communicate with one another on a peer-to-peer level. For example, the clients 26 can share files with one another directly, without sending the files to the server 12.

The system 10 facilitates improved communication between authors during the process of collaboratively developing educational materials. For example, a plurality of authors may develop separate modules for a single project or course. Alternatively, a group of authors may jointly develop a single module of the course. The authors can access the course materials from separate clients 26. Such collaborative authorship typically requires each of the authors to be able to access some or all of the course materials. As such, many of the course materials (e.g., courses, projects, educational modules, objects, media objects) will be available for access and revision by more than one author, depending upon the permissions scheme for the content. From a single author's point of view, each time he or she logs in and accesses a particular content element (e.g., a course), it is possible that the element may have been modified by another author beforehand. It is also possible that other authors will revise the content element during the author's session.

For clarity, it should be understood that when an author logs in or connects to the server 12 from a client 26, the author can obtain current versions (“synchronize”) of course materials without checking-out the materials from the server. It is intended that the act of checking-out course materials is to be done only when the author wishes to edit such materials. If the author merely downloads current versions of course materials without checking them out, those materials may be available for check-out and modification by other authors during the initial author's session.

In one embodiment of the invention, the system 10 advantageously sends messages to the various authors to inform them about content revisions. In one embodiment, the system 10 also permits an author to synchronize one or more course materials with the latest versions available on the server 12. In other words, an author can instruct the system 10 to transmit the latest versions of content objects and the most recently updated structure of a given content element or group of elements to the author's client 26. This process is herein referred to as synchronization of content with the server. The synchronization tasks are implemented by the synchronization engine 18.

The system 10 preferably comprises a plurality of banks (or repositories) for storing content objects and document files, image files, sound files, video files, text files, animation files and other types of files that can be used for the presentation of material. As an example, the system 10 may include a document repository for storing Microsoft Word documents and/or Microsoft PowerPoint files. As another example, the system 10 may include a media repository for storing image files. As another example, the system 10 may include an assessment item (AI) repository, a content item (CI) repository, and/or a content section (CS) repository. In some embodiments, the system 10 is configured to perform real-time messaging to users (e.g., authors, administrators) when a change is made to any of the repositories. As an example, when an image file is added to a media repository, authors will receive a message informing them of the addition.

In a preferred embodiment, authors can access the plurality of repositories to pick-and-choose content for incorporation into content objects. As an example, an author may access a media repository and choose a particular image file for insertion into a content item under construction. As another example, an author may access an AI repository and choose a particular AI to incorporate into a target indicator (TI). In some embodiments, authors incorporate content in various repositories via pointers (or links) to the content. In other embodiments, contents are copied into the content object under construction.

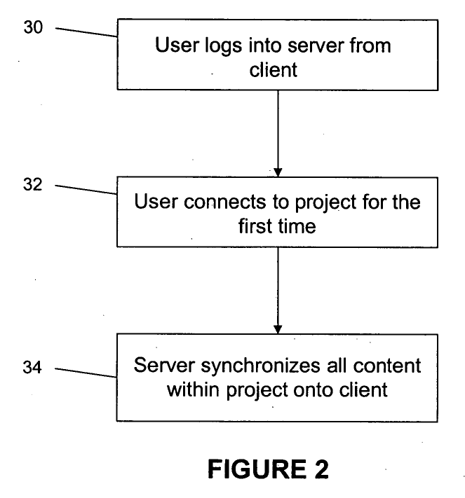

Synchronization of content between a client 26 and server 12 can be performed automatically in certain cases. FIG. 2 is a flow chart describing a process in which an author logs into the server 12 from a client 26, in a step 30. In a step 32, the author “opens” (i.e., indicates intent to access for viewing) a specific project for the first time on that particular client. At this stage, the author has not checked-out the project, but has merely requested to download its hierarchical outline for viewing. As used herein, a project describes educational content containing a plurality of different objects. The project may include one or more lessons (or courses) within a course curriculum, or may refer to the entire curriculum. In a step 34, the server 12 automatically synchronizes all of the content within that particular project onto the client 26. In an alternative embodiment (not illustrated), the author selects to synchronize with the server. Upon synchronization, the server 12 transmits the latest version of the project to the client, with all of the most recent versions of all of the project objects. As explained below, the synchronization engine 18, and particularly the rules engine 20, is responsible for the synchronization tasks. The author may subsequently “close” the project. While the project is closed, the project content preferably remains saved within the author's client database 28. During this time, it is possible that other users may check-out, modify, and check-in the project, which would make the project version saved on the initial author's database 28 a previous version. In some embodiments, if the initial author re-opens the project and a current or previous version of the project remains on the author's client 26, the server 12 will run a diff procedure (see below) and allow the author to synchronize with the latest version of the project. However, if the project does not remain on the author's client 26 (e.g., if the author has manually deleted the project from the client 26), the server 12 may automatically transmit all of the latest content within the project onto the client 26.

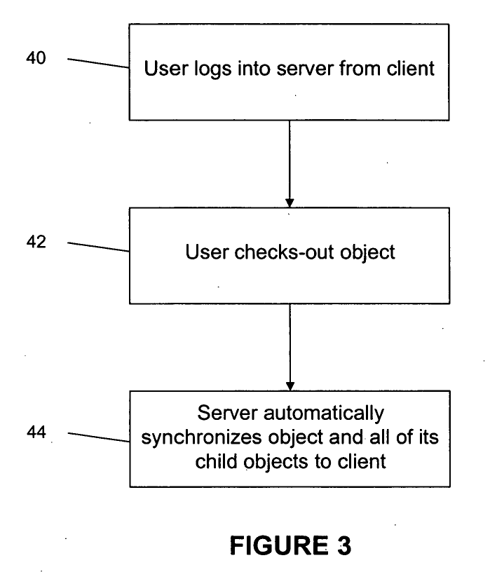

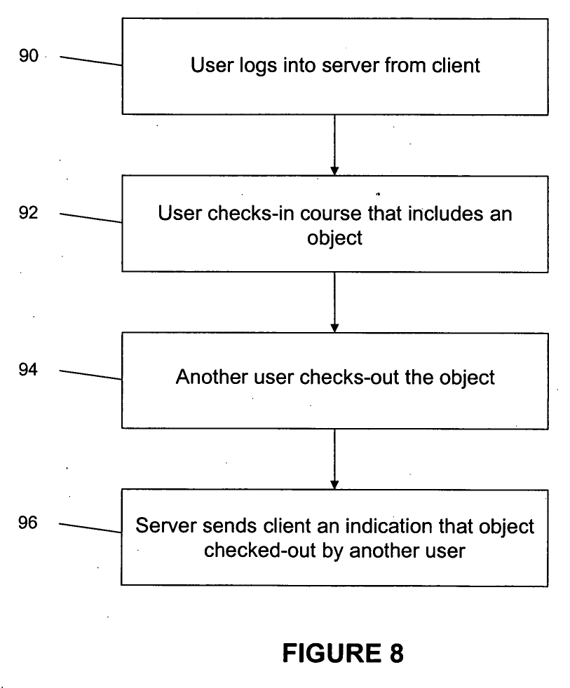

FIG. 3 is a flow chart describing a process in which the server 12 automatically synchronizes an object and its “child objects” when an author checks-out the object. As noted above, an object represents course material, such as a course itself, a subsection of the course, or a single content item or content section. An object's child objects are all of the objects below the object in the object-oriented hierarchy. For example, an object may include a content item comprising content items and content sections. As another example, an object may include a particular chapter of a course that includes a plurality of content items and content sections. According to the illustrated process, the author logs into the server 12 from a client 26, in a step 40. In a step 42, the author checks-out an object. In a step 44, the server 12 checks whether the author's local database 28 includes the current version of the object and all of its child objects (if any). If the versions of the object and all child objects on the client 26 are not current with respect to those on the server 12, the object and all of its child objects are automatically synchronized with the server 12. In an alternative embodiment (not shown), if the versions of the object and all child objects are not current, the user selects to synchronize with the server 12. However, in some embodiments, if the versions of the object and all child objects on the client 26 are current, synchronization will not be required. In either case, other clients' displays will be adjusted to visually indicate that the object and all of its child objects have been checked-out, as described below in the context of FIG. 8.

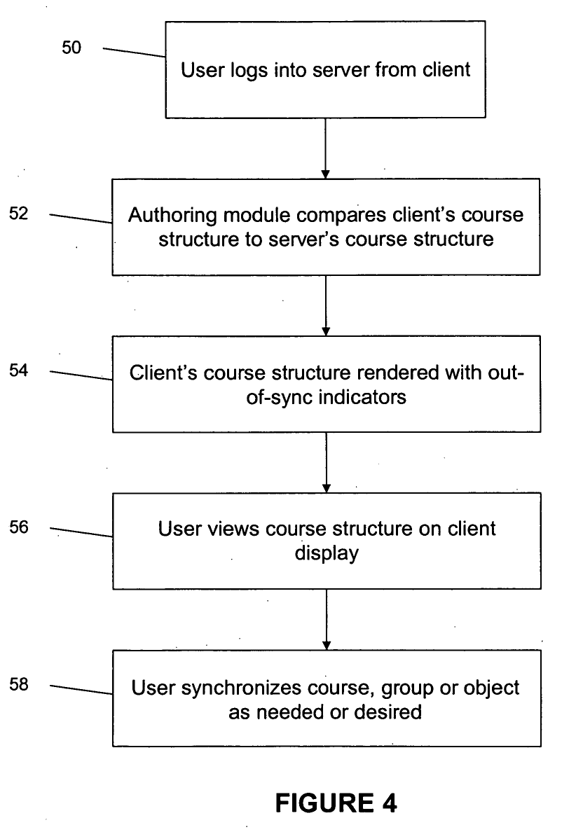

Synchronization of selected content between a client and server can be initiated by an author's request. FIG. 4 is a flow chart describing a process in which an author can selectively synchronize content, in accordance with one embodiment of the invention. In a step 50, the author logs into the server 12 from a client 26. In a step 52, the authoring module 25 or the synchronization engine 18 compares a particular project structure (e.g., object tree) stored on the client database 28 with the most recently updated corresponding project structure stored on the server 12. The author is able to view the project structure because, e.g., the author has previously worked on this particular project on this client and the project structure was saved locally on the database 28. If there is a difference between the project structures stored on the client database 28 and the server 12, the client's project structure is rendered on the client 26 with “out-of-sync” indicators, in a step 54. For example, objects that have been revised (perhaps by other authors) are shown visually differentiated in the project structure from objects that have not been revised (“current”). Also, objects that have been deleted can be visually differentiated from both the current and revised objects. For example, a deleted object may appear as a “phantom” object on the client's display. It will be understood that if all of the objects in the client project structure are current, then there is no need to activate the out-of-sync indicators for any of the objects. In a step 56, in one embodiment, the author views the project structure on the client display without checking out the project from the server 12. The project structure can be represented in a variety of ways, for example as a project tree showing the hierarchy of objects within the project. In some embodiments, if a child object is out-of-sync, the project tree may be expanded to show the out-of-sync child object. If some of the content is out-of-sync, then the author can initiate synchronization of selected content (e.g., an object, a group of objects, or the whole project), onto the client 26 in a step 58. However, in some embodiments the author can permit the server 12 to automatically synchronize all content onto the client 26 without the author's instruction. In an alternative embodiment, step 54 is replaced by a step in which the server 12 sends the author (or authors) a text message informing the author of the change. In some embodiments, if a child object is modified, the project tree will not be expanded to reveal the out-of-sync child object. The author may expand the project tree and view the out-of-sync object when desired, and synchronize with the server 12.

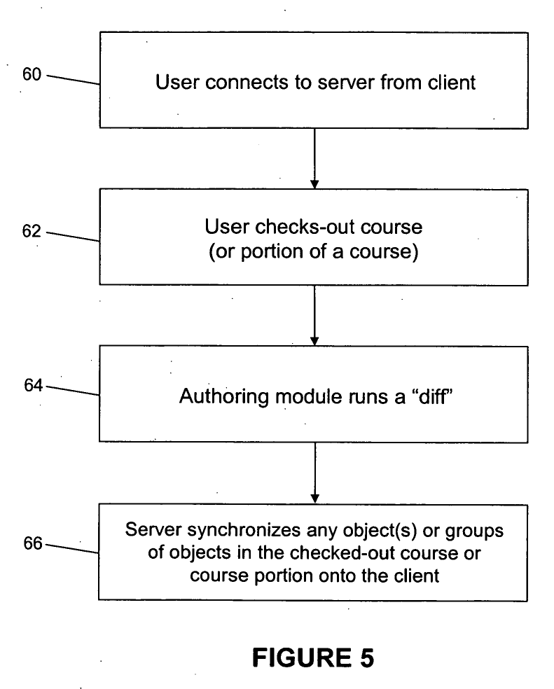

FIG. 5 is a flow chart of a process in which the author's authoring module 25 (FIG. 1) runs a “diff” procedure. In a step 60, an author connects to the server 12 from a client 26. In a step 62, the author checks-out a course (or a portion of a course). In a step 64, the client's authoring module 25 runs a diff procedure, whereby the authoring module determines which content objects within the course are out-of-sync with the server, for the checked-out course. The diff procedure can optionally determine all of the differences between the client's version of the course and the server's version. Suppose one or more objects are out-of-sync with the server. Then in a step 66, the server 12 automatically synchronizes any out-of-sync object or group of objects in the checked-out course onto the client 26. In an alternative embodiment (not shown), the author selects to synchronize any out-of-sync object or group of objects on the client 26 with the server 12. Transmitting only the out-of-sync object or group of objects to the client 26 can improve system (and network) performance, as potentially less data is transmitted per synchronization.

In many cases, the information in the content database 14 (FIG. 1) will be changed during a particular author's session on the system 10. This occurs when the author, other authors, organizational administrators, or super administrators “check-in” new or revised content into the database 14. If the newly checked-in content is relevant to the content in use (i.e., content that has been downloaded but not checked-out) by the author, the system 10 informs the author of the new content and provides synchronization options. Some examples of this follow.

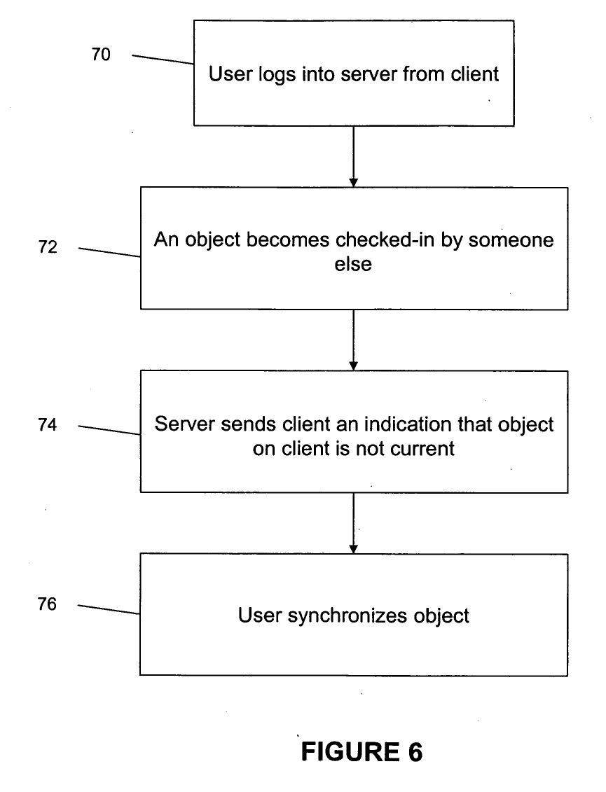

FIG. 6 is a flow chart of an exemplary process. In a step 70, an author logs into the server 12 from a client 26 and only sees the object hierarchy; no object or groups of objects are checked out, but objects are stored locally on the client 26 from a previous synchronization. In a step 72, an object (either alone or as a group of objects) becomes checked into the content database 14 (also described herein as becoming checked into the server 12) from another user. For example, the object can be checked into the database 14 from a super administrator, organizational administrator, or a different author (typically from a different client 26). The system checks whether there are any changes to the object. Suppose this is so. In a step 74, the server 12 sends the author an indication that the corresponding object on the author's client 26 is not current. In some embodiments, in step 74 the server 12 sends the author (or authors) a text message indicating that the locally stored object is not current. In other embodiments, in step 74 visual indications are rendered on a display of the author's client 26 to indicate that the object is not current. In a step 76, the author requests a synchronization of the object to obtain the current version.

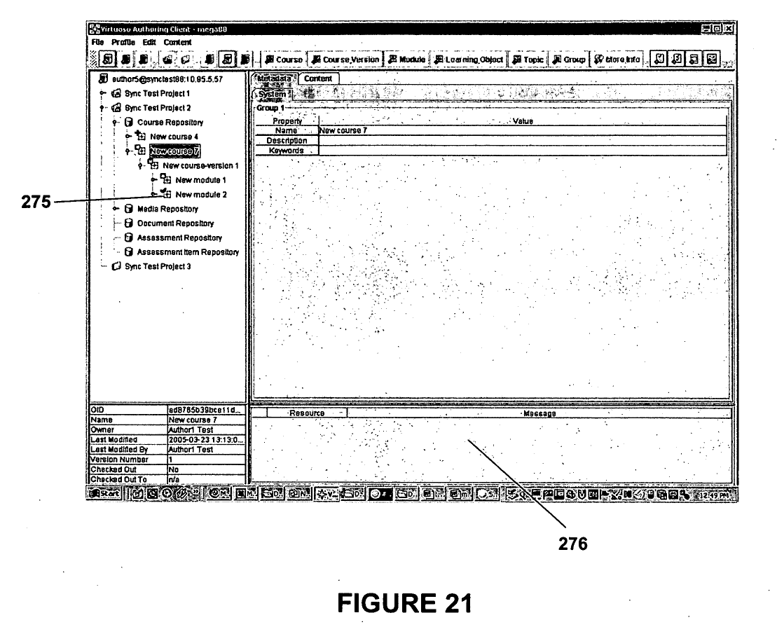

Text messaging in regards to a modification made to an object, as discussed, e.g., in FIGS. 4 and 6, may provide a variety of information to the author. The text message may inform the author as to which user (or author) made the change to the object, where the change was made (i.e., which object was changed), a time or time period in which the change was made, comments (if any) provided by the user that made the change, and/or what kind of change was made to the object (e.g., whether the object was edited or rolled back to a previous a newer version, etc.). The skilled artisan will appreciate that text messaging may apply to a plurality of objects. As an example, a text message may indicate that a parent and a child content object within a particular course were edited by a particular author. In some embodiments, the text messages include metadata describing the change. Such text messages can be provided in, e.g., a message pane 276 (FIG. 21).

In preferred embodiments, when an object (either alone or as a group) is edited, the previous version of the object is not deleted from the server 12. The modified object is saved as a new version of the object in the server 12. Saving successive iterations of an object advantageously permits authors to “roll-back” to a previous version of the object, in which case the most current version of the object is replaced with a previous version. Also, if an author checks-out an object from the server 12, the author can subsequently perform an “undo check-out,” in which the server 12 is instructed to roll-back to the version of the object prior to the check-out. In such a case, other authors working on the project are not informed of any changes to the object. In another aspect, an author that checks-in an object can subsequently perform an “undo check-in,” which instructs the server 12 to roll-back to the version of the object prior to the author's previous check-in.

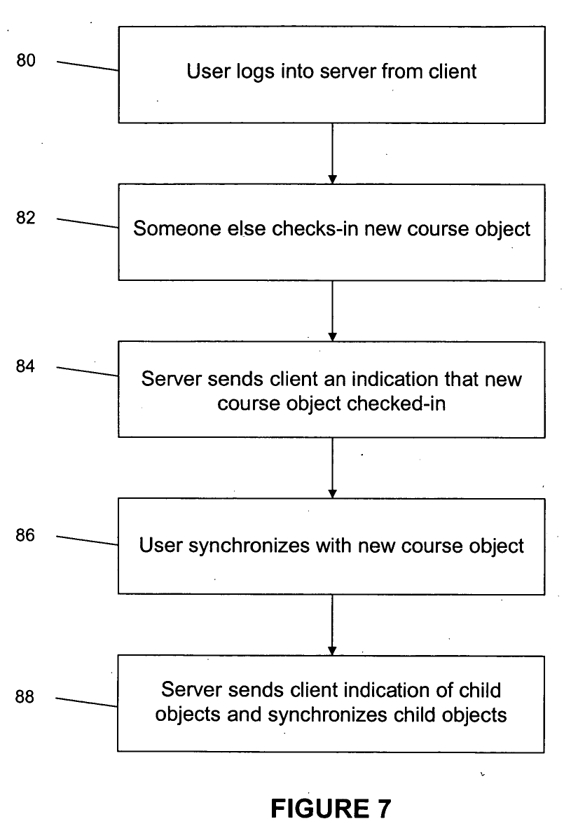

FIG. 7 is a flow chart of a process in which a course becomes checked into the content database 14 during an author's session. Preferably, the course is an object with no parent object. The illustrated process begins in a step 80, wherein an author logs into the server 12 from a client 26. In a step 82, a new course object (or modified version of a checked-out course object) becomes checked into the content database 14 by someone else. In a step 84, the server 12 sends the author an indication that the new course object has been checked in. In some embodiments, this step entails sending the author a text message indicating that the new course has been checked in. In the illustrated embodiment, a new course object (but preferably not its child objects) is rendered on the author's client 26 with an out-of-sync indication. In a step 86, the author requests and has performed a synchronization of the new course object. In a step 88, the server 12 sends the author an indication of the course object's child objects and synchronizes them with the client 26. Thus, by synchronizing with the new course object, the author has also synchronized with the course object's child objects. In an alternative embodiment, the system responds to the author's request for synchronization of the top-level course object by rendering the child objects on the author's client display with out-of-sync indications, without synchronizing the child objects. In this alternative embodiment, the author can preferably selectively synchronize the child objects as desired.

FIG. 8 is a flow chart of a process in which an object is checked-out during an author's session. In a step 90, an author logs into the server 12 from a client 26. In a step 92, the author checks-in a course including a given object. In a step 94, another user (e.g., an administrator or a super administrator) checks out the object during the author's session. In a step 96, the server 12 sends the author an indication that the object has been checked-out by another user. With the object checked-out by another user, the author will not be able to check-out any parent objects for which the checked-out object is subservient (such as, e.g., the course), or child objects that serve the checked-out object. However, the author is preferably able to check out sibling objects (i.e., objects at the same level as the checked-out object).

Preferably, upon checking out an object, all objects subservient to the checked-out object (i.e., child objects) will also be checked out. For example, if a user checks out a content item, all content items and content sections below the checked-out content item in the course hierarchy will also be checked out.

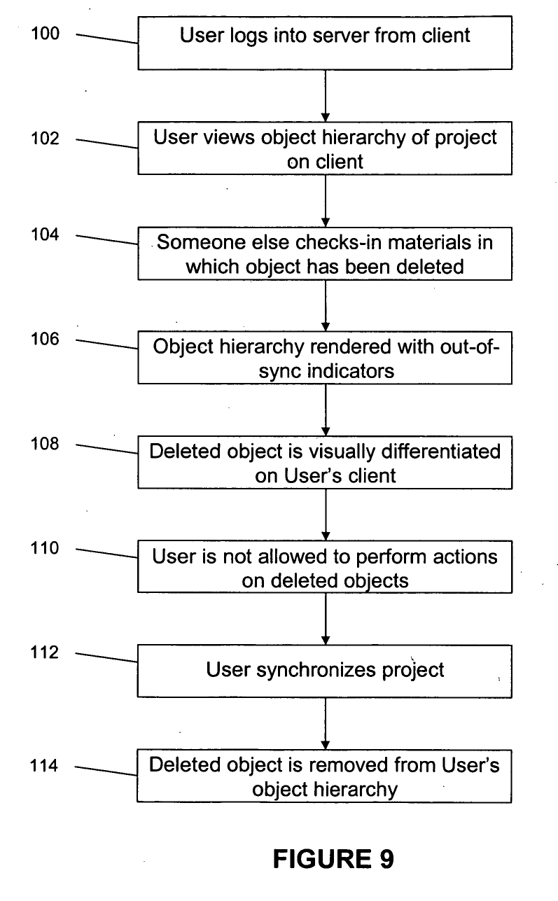

FIG. 9 is a flow chart of a process in which an object is deleted by another user during an author's session. In a step 100, an author logs into the server 12 from a client 26. In a step 102, the author views an object hierarchy of a project, without checking out the project. In a step 104, someone else performs a check-in in which an object of the project has been deleted. For example, another author working on the project may have decided to delete the object from that particular project. In a step 106, the project's object hierarchy is rendered on the initial author's client 26, preferably with out-of-sync indications as described above in connection with FIG. 4. In a step 108, the deleted object becomes visually differentiated on the author's display, to indicate that the object has been deleted from the project. As an example, the deleted object may be rendered in phantom upon check-in. In a step 110, the author's client switches to a mode in which it will not allow the author to perform any actions on the deleted object. In a step 112, the author synchronizes the project. In a step 114, the deleted object is removed from the author's display.

Course materials are preferably divided into discrete portions that can be mixed and matched as desired. This approach also adds granularity to the content repository, making it easier to dynamically render content onto a client 26. Educational content may be divided into a hierarchy that comprises courses, learning objectives, target indicators, content items, content sections, etc. As used herein, a content module refers to a specific element in this hierarchy. Suppose a first course includes a given content module. In one embodiment, a second course can include a read-only copy of the content module, referred to herein as a “reference” to the content module. In this context, “read-only” means that authors of the second course do not have permission to revise the referenced course module. From the student's perspective, the referenced content module will appear to be a seamless portion of the second course. If the original content module becomes revised, the reference needs to be updated. In another possibility, the second course can include an editable copy of the content module from the first course, referred to herein as a “repurpose” of the content module. In such a case, the author of the content module permits other authors to insert the content module into other courses and to modify the content module as desired. In yet another possibility, the second course can include a pointer to the content module of the first course, referred to herein as a “link” to the content module. For example, a content page can have a button labeled “Click Here For More Information About This Topic,” which can link to related content that supports the main topic but is not core material. Activation of the link calls the specific content module from the first course of the content database 14.

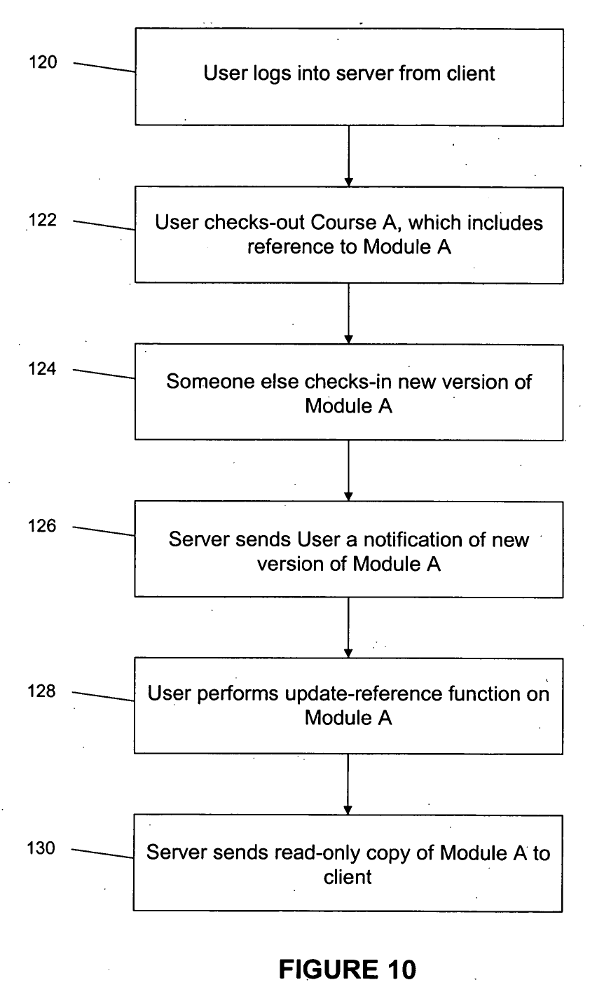

FIG. 10 is a flow chart of a process in which an author updates a “reference” in a given course material. The illustrated process begins in a step 120, in which an author logs into the server 12 from a client 26. In a step 122, the author checks out Course A that includes a reference to Content Module A (Module A, as illustrated) from a different project. In a step 124, a new version of Content Module A is checked into the server 12 by someone else. In a step 126, the server sends the author (as well as all other users working on the project) a notification of the new version of Content Module A. In some embodiments, the Content Module A is rendered with an out-of-sync indication within a hierarchical project or course outline on the author's client display. The author can perform an “update-reference” function on Content Module A, illustrated as step 128. In a step 130, the server 12 transmits a read-only copy of the new version of Content Module A to the author's client 26.

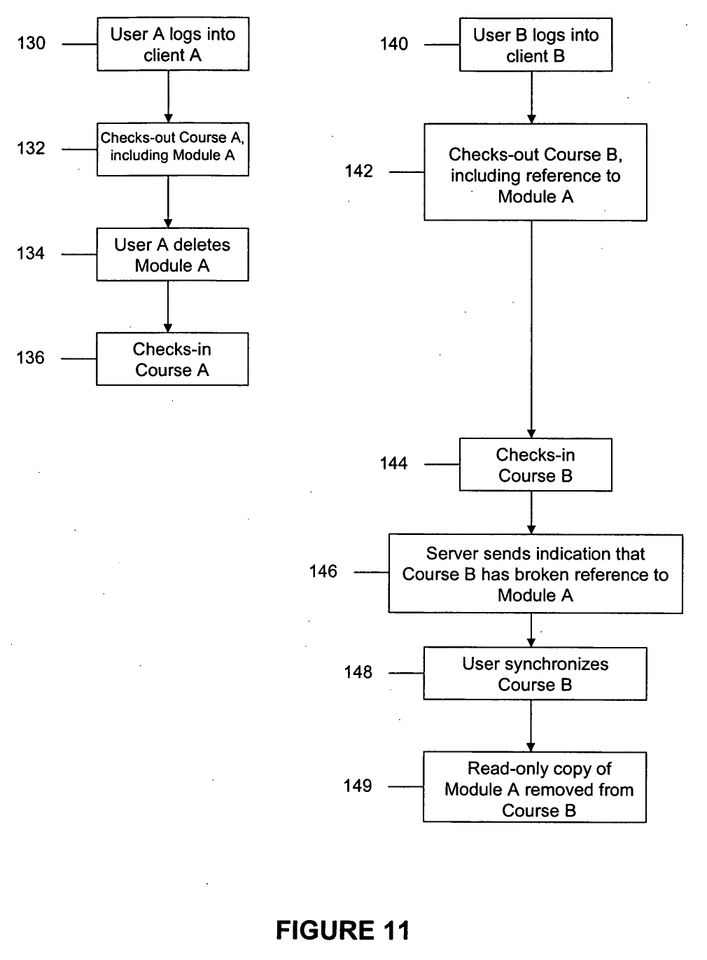

FIG. 11 illustrates how the server 12 informs an author of an invalid or “broken” reference. FIG. 11 includes two parallel flow charts, one for each of two authors. In steps 130 and 140, authors A and B log into clients A and B, respectively. In a step 132, author A checks out Course A, which includes Content Module A. In a step 142, author B checks out Course B, which includes a reference to Module A. In a step 134, author A deletes Module A. In a step 136, author A checks in Course A into the server 12. In one implementation (not illustrated in FIG. 11), author B receives a notification of the deletion of Module A when author A checks-in Course A. In the illustrated embodiment, author B is notified of the deletion only after author B checks-in Course B. Accordingly, in a subsequent step 144, author B checks Course B into the server 12. In a step 146, the server sends client B an indication that Course B contains a broken reference to Module A. In one embodiment, the Course B object hierarchy is rendered on client B, showing a visually differentiated reference to Module A. In a step 148, author B opts to synchronize Course B with the server 12. In a step 149, the reference (i.e., read-only copy of Module A) is removed from Course B.

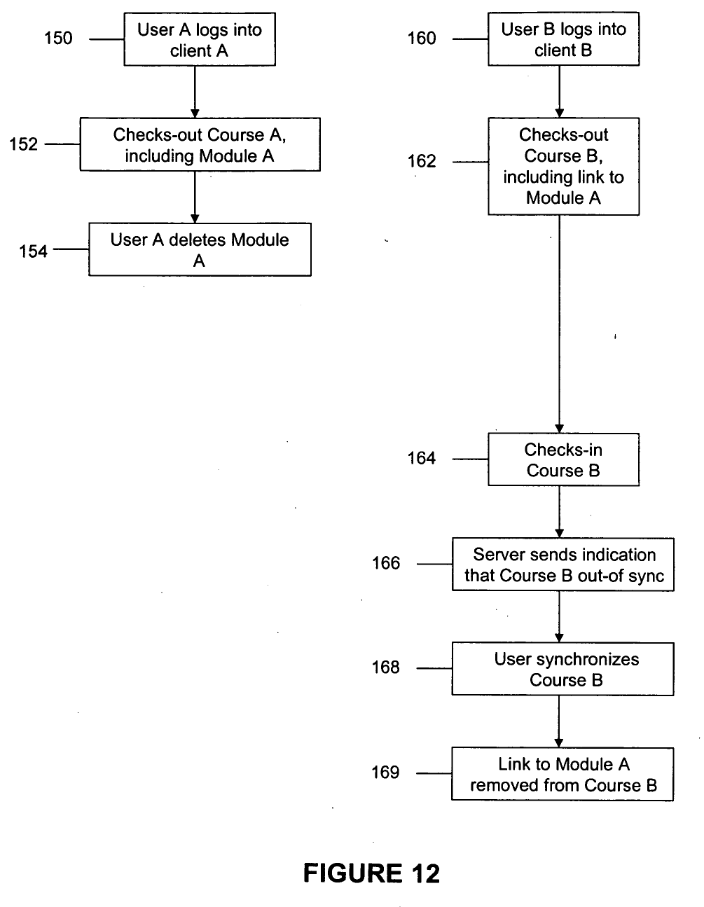

FIG. 12 illustrates how the server 12 informs an author of an invalid “link.” FIG. 12 includes two parallel flow charts, one for each of two authors. In steps 150 and 160, authors A and B log into clients A and B, respectively. In a step 152, author A checks out Course A, which includes Content Module A. In a step 162, author B checks out Course B, which includes a link to Module A. In a step 154, author A deletes Module A and then checks in Course A into the server 12. In one implementation (not illustrated in FIG. 12), author B receives a notification of the deletion of Module A when author A checks-in Course A. In the illustrated embodiment, author B is notified of the deletion only after author B checks-in Course B. Accordingly, in a subsequent step 164, author B checks Course B into the server 12. In a step 166, the server 12 sends client B an indication that Course B is out-of-sync with the server. In one embodiment, the Course B object hierarchy is rendered on client B, showing a visually differentiated link to Module A. In a step 168, author B opts to synchronize Course B with the server 12. In a step 169, the link to Module A is removed from Course B.

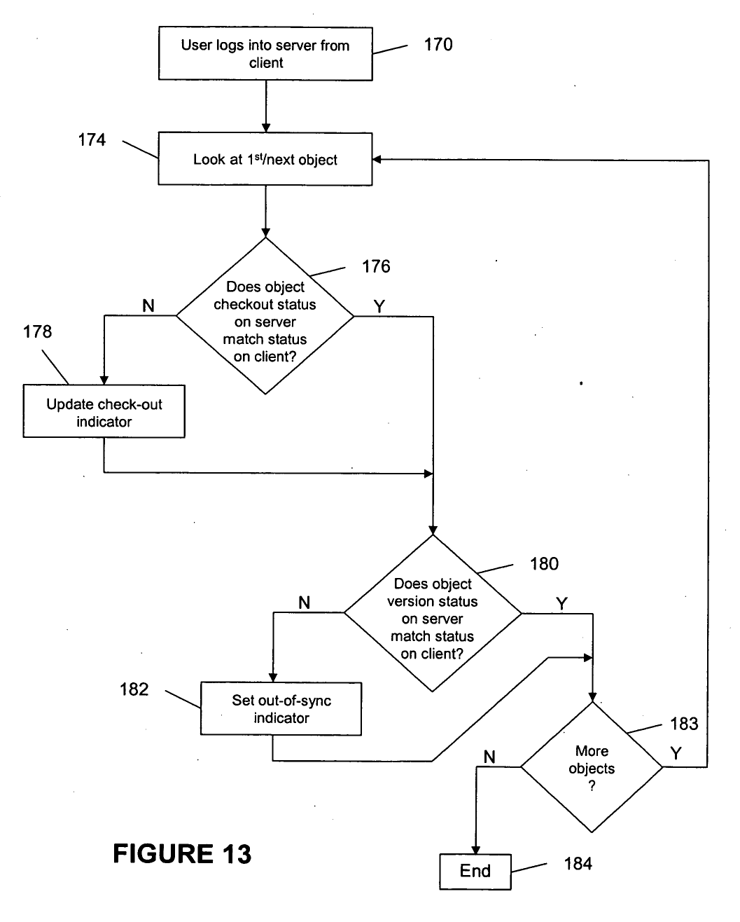

The system 10 preferably provides an author with status indicators for each of the objects that an author may be using. Status indicators are preferably shown on a client display. FIGS. 13-15 illustrate examples of the use of status indicators.

FIG. 13 is a flow chart of a process by which the server 12 and client 26 communicate to give the author the current status of the objects. For any given object, the server and client both include information about whether the object is checked-out to the client (“checkout status”) and whether the version on the client matches that on the server (“version status”). The client is preferably configured to provide status indications of the checkout status and sync status for each object. These status indications can be conveyed to the author by activating “status indicators” on the client display. Status indicators can comprise any of a large variety of visual indications, such as icons, colors, etc.

The illustrated process begins in a step 170, in which an author logs into the server 12 from a client 26 and views a course (or content object) hierarchy. In a step 174, the synchronization engine 18 (FIG. 1) retrieves the data for the first object in the course. In decision box 176, the synchronization engine 18 determines whether the object's check-out status on the server 12 matches its status on the client 26. If they match (e.g., the server and client both reflect that the object is checked in or checked out), the process proceeds to a decision box 180. If they do not match, then, in a step 178, the check-out status indicator for the object (i.e., an indication of whether the object is checked-in or checked-out) is updated on the client 26. After the step 178, the method proceeds to the decision box 180. In the decision box 180, the synchronization engine 18 determines whether the object's version status on the server 12 matches its version status on the client 26. If they match, then the process proceeds to a decision box 183. If they do not match, then, in a step 182, an out-of-sync indicator is activated for the object. After step 182, the process proceeds to the decision box 183. In the decision box 183, the synchronization engine 18 determines whether there are any more objects in the course. If there are more objects, then the process returns to step 174, in which the synchronization engine 18 retrieves the data for the next object and repeats the aforementioned steps. If there are no more objects, the process ends in step 184.

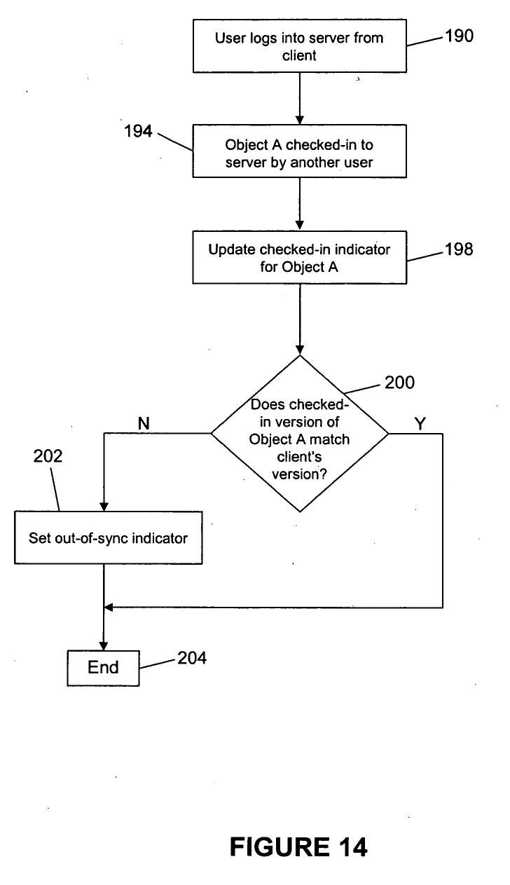

FIG. 14 is a flow chart illustrating a process in which the server 12 updates a client's status indicators when an object becomes checked into the server (from someone else) during the author's session. In a step 190, an author logs into the server 12 from a client 26 and views a project or course structure. Suppose the author's client has a locally stored version of the project or course material, which includes an Object A. Suppose further that Object A is currently checked-out by another user (e.g., from another client or from a super administrator at the server 12), and the rendered project structure therefore has a checked-out indicator for Object A. In a step 194, Object A becomes checked into the server 12 by the other user. In a step 198, a check-in indicator for Object A is activated on the author's client 26. After step 198, the process proceeds to a decision box 200. In the decision box 200, the synchronization engine 18 determines whether the checked-in version of Object A matches the client's version of Object A. If they match, then the process ends in the step 204. If the two versions of Object A do not match, then, in a step 202, an out-of-sync indicator for Object A is activated on the client 26, after which the process ends in the step 204. In some embodiments, the author may optionally synchronize with the checked-in version of Object A, which may involve the server transmitting a copy of the checked-in version of Object A to the author's client 26.

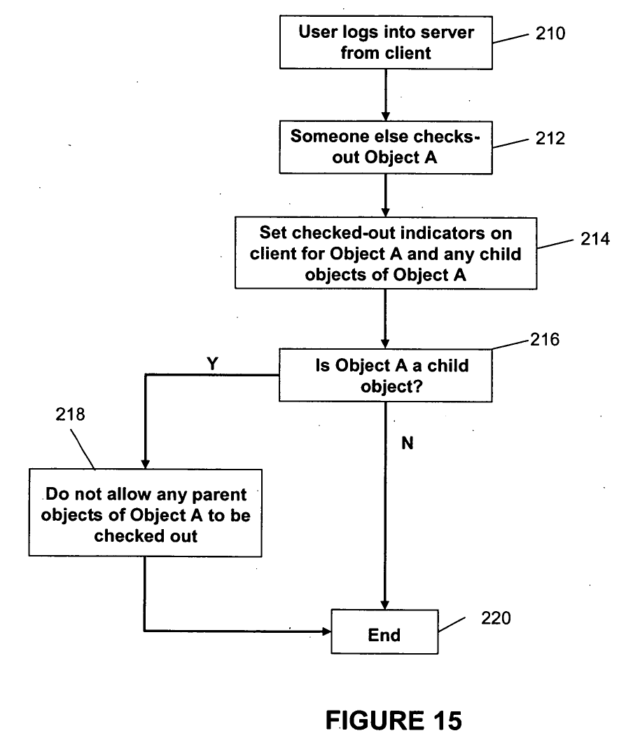

FIG. 15 is a flow chart illustrating a process in which the server 12 updates a client's status indicators when an object becomes checked-out of the server (by someone else) during the author's session. In a step 210, an author logs into the server 12 from a client 26. Suppose that the author views the structure of a project or course material containing an Object A that is currently checked-in. The author's client display preferably shows the structure with a checked-in indication for Object A. In a step 212, someone else (e.g., another author or a super administrator) checks out Object A. In a step 214, check-out indicators for Object A and preferably all child objects of Object A are activated on the author's client 26. After step 214, the process proceeds to a decision box 216, at which point the synchronization engine 18 determines whether Object A (which was checked-out by someone else) is itself a child object. If Object A is not a child object, the process ends in a step 220. If Object A is a child object, then, in a step 218, all parent objects of Object A are prevented from being checked out by any users other than the user that checked-out Object A. However, it will be appreciated that while Object A's parent and child objects cannot be checked-out, the author may check out any sibling object (i.e., an object that serves the same parent of Object A and is not a child object of Object A).

The specific action to be performed upon a synchronization of an object preferably depends upon the object's status on the server and the client, i.e., the object's checkout status, version status, and “delete flag.” An object's delete flag is an indication of whether the object has been tagged as deleted. A delete flag has a value of yes or no. In one embodiment, the system 10 (server, synchronization engine, etc) is configured to perform an “update all” action. Suppose the records on both the server and the client show that an object in question is checked into the server, but that the server version of the object is newer than the version on the client. Through the update all action, the server transmits the new version of the object to the client. In another embodiment, the system 10 is configured to inform an author that a version of a checked-out object on the author's client is not up-to-date with the version of the object on the server. In some embodiments, the author may synchronize with the version of the object on the server. In another embodiment, the system 10 is configured to regulate simultaneous check-out of one or more objects. For instance, if authors A and B substantially simultaneously request to check out an object (or author A requests the object and author B requests a child or parent object), and author A's request was received and completed by the system 10 before author B's request, then the system 10 will permit author A to check out the object and will inform author B that the object (or child object, parent object) cannot be checked out. It will be appreciated that the system 10 will grant check-out of the object based on the order in which the transaction was completed by the system 10. Following check-out of the object to author A, author B's version of the object will be rolled-back to the latest version on the server 12, and author B will be permitted to check out other objects.

In another embodiment, a user (e.g., author, administrator, super administrator) has the ability to roll-back the revisions made to a particular object (e.g., content item, content section, etc.), such as revisions made by other users. Thus, the server 12 can be configured to store any number of successive versions of the object (e.g., version 1, version 2, version 3, etc), and permit an author to revert (or roll-back) to a previous version. In such a case, other users will be informed of the roll-back event through, e.g., visual indications such as out-of-sync indicators, and will be permitted to have their clients synchronize with the server, as described above.

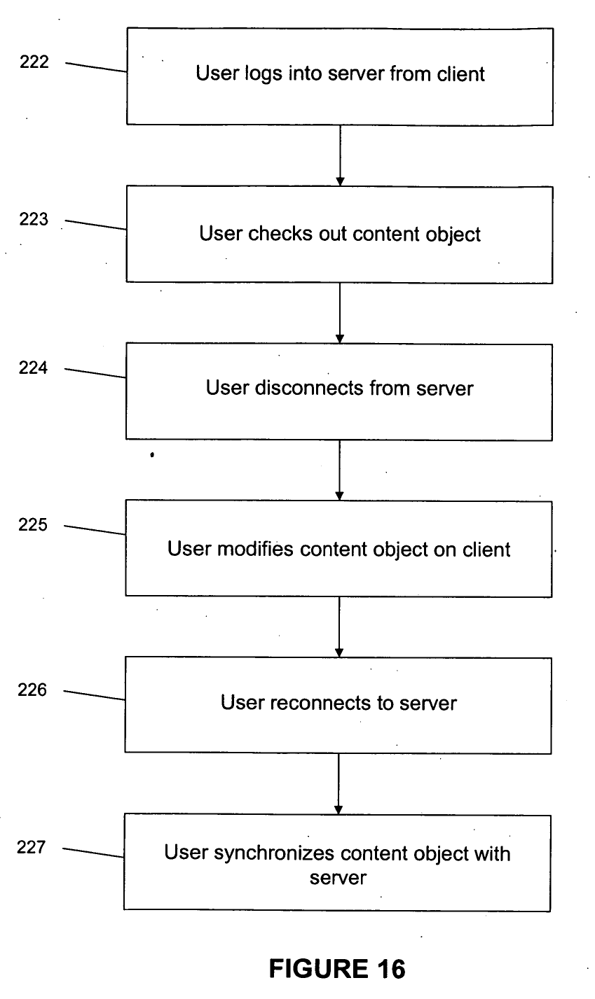

FIG. 16 is a flow chart illustrating a process in which a user modifies a content object off-line, i.e., while disconnected from the server 12 (or storage). In a step 222, a user (e.g., author) logs into (or connects to) the server 12 from a client 26. In a step 223, the author checks out a particular content object. In some cases, this may include checking out subservient content objects. As discussed above, preferably no other author will be permitted to check out the content object (or any parent or child content objects) after it has been checked out by the author. In a step 224, the author disconnects the client 26 from the server. In some cases, this step entails disconnecting the client 26 from the network. In a step 225, the author modifies the content object on the client 26 while disconnected from the server 12. The author may, for example, edit the content object or remove particular child content objects. In a step 226, the author reconnects the client 26 to the server 12. In a step 227, the server synchronizes with the client 26. In one embodiment, this step entails the server 12 running a diff procedure to determine the differences between the server's version of the content object and the version on the client 26. In such a case, synchronization involves transmitting the out-of-sync portions of the content object from the client 26 to the server 12. In another embodiment, the server 12 requests the content object in its entirety from the client 26 without running a diff procedure. The user may also check-in the object after step 226.

Data Management

Each object preferably has a unique OID, or object identifier. The version status for each object is preferably maintained by a counter that increments its count by one each time a new version of the object is checked into the server 12. Similarly, the delete flag for an object can be updated (either “yes” or “no”) with every new check-in of the object or content containing the object. For example, an author can check-in a course in which the author deleted a certain object therefrom. Upon check-in of the course, the server 12 updates the object's delete flag from “no” to “yes.”

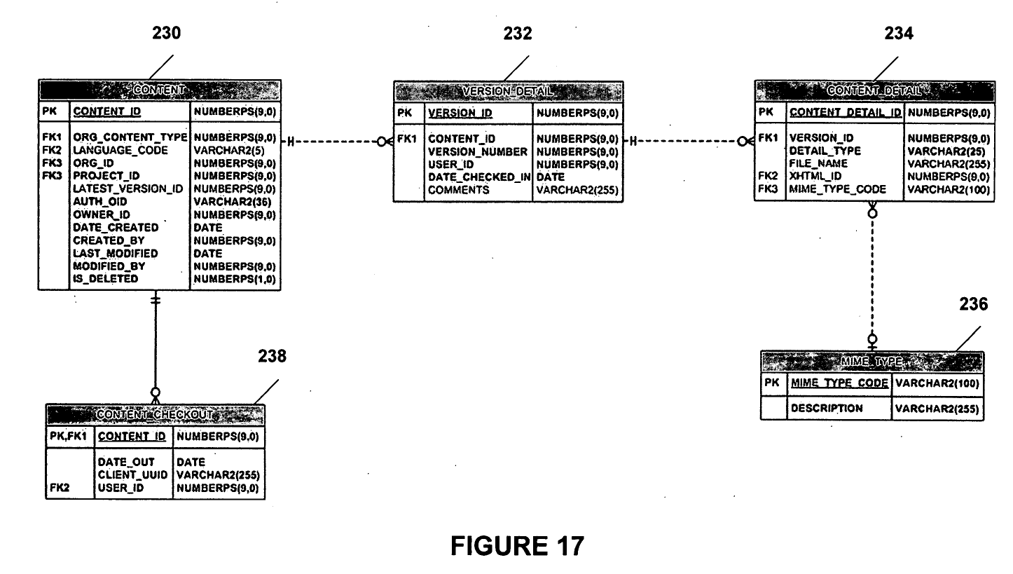

FIG. 17 is a schematic representation of a database model of the system 10. The illustrated model includes a number of data structures (collectively defining an object, such as a content item). In the illustrated embodiment, the data structures include a content structure 230, a version detail structure 232, a content detail structure 234, a MIME-type structure 236, and a content checkout structure 238. The content structure 230 indicates that the object is owned by a particular organization. Multiple content detail structures 234 may depend from the version detail structure 232, which in turn may depend from a parent object, such as, e.g., a target indicator (TI). Each MIME-type structure 236 is associated with a content detail structure 234, and indicates the type of content item each content detail structure 234 comprises. The content checkout structure 238 indicates when an object was modified, checked out, checked in, deleted, etc.

User Interface

The clients 26 can include software, hardware, or firmware modules to enable users to modify a project's object hierarchy, create new objects, delete objects, update objects, update references and links, and the like. The user interface can be configured to provide a synchronization option, for example as a right-click menu option or as a content menu option. Prior to user-initiated synchronization tasks that may be very time-consuming, a warning dialog can be sent to the client display to request confirmation of the synchronization.

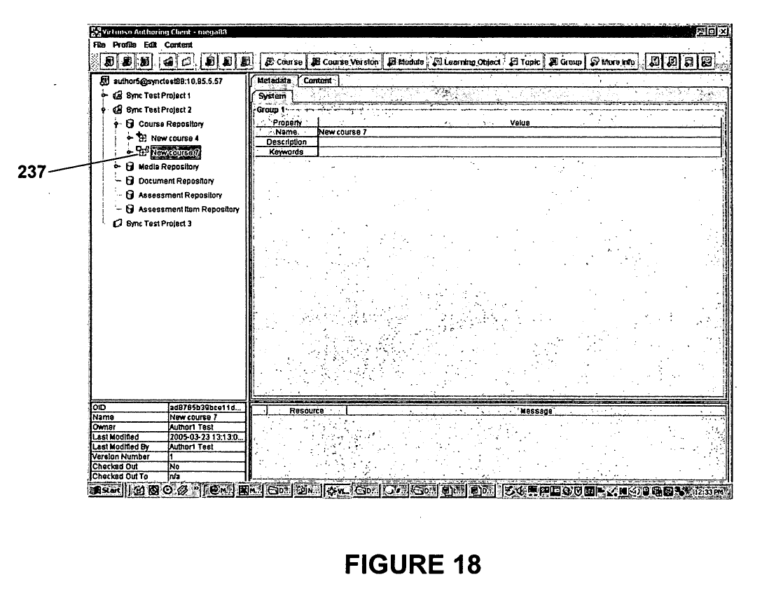

FIGS. 18-24 are screenshots of a client display according to one embodiment of an authoring module 25 (FIG. 1) of the invention. These screenshots show the display for a User 2. The screenshot of FIG. 18 shows that a User 1 has added new content under “New Course 7.” The screen preferably includes a visual indication that User 1 has added the new content. For example, an exclamation point can be superimposed on the text “New Course 7,” such as at 237, to indicate that the course has been updated by another user. The exclamation point is a visual indication activated by the client's user interface module 27 (FIG. 1) in response to an event message received by the messaging module 29 from the server 12.

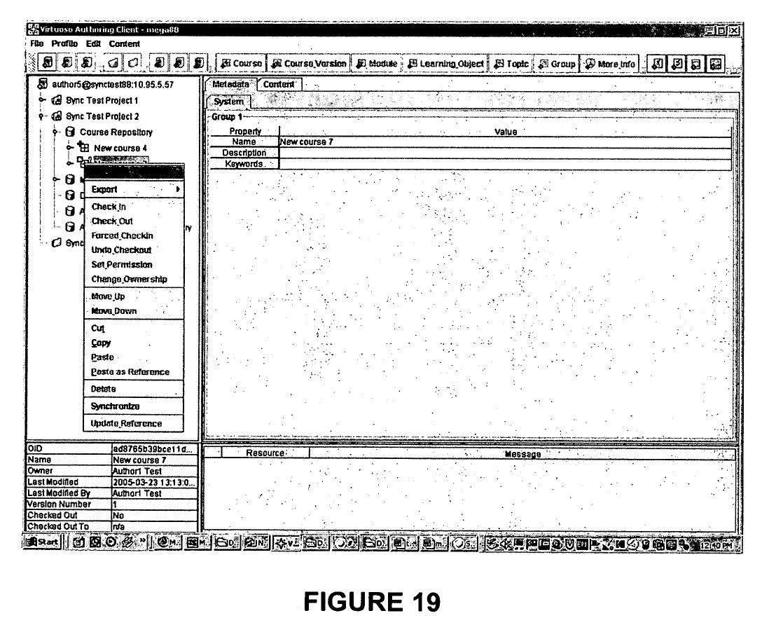

The screenshot of FIG. 19 illustrates how User 2 can, at the user's discretion, choose to synchronize content to get updated material from the server 12. The synchronization menu option is obtained by, e.g., a right-click of the computer mouse. Where the system 10 deems the certain functions applicable, the user may perform other functions, such as “Check-in” or “Check-out” (as described above), “Forced Check-in” and “Undo Check-out.” In a forced check-in, a checked-out object (i.e., checked-out by another user) is forcibly checked-into the server, preferably by being rolled back to the latest version of the object on the server. Preferably, the forced check-out option is only available to users having higher level permissions, such as organizational or super administrators. A forced check-out may be appropriate if, e.g., another author's client fails or becomes inoperative while an object is checked-out thereto. An undo check-out simply checks-in an object as it existed upon check-out, such that any changes to the object are not saved onto the server. An undo check-out may be appropriate if an author does not want to retain changes made to the object. Upon an undo check-out, the system 10 preferably does not notify other users of a new version of the object, since the checked-in version is the same as the previously checked-out version.

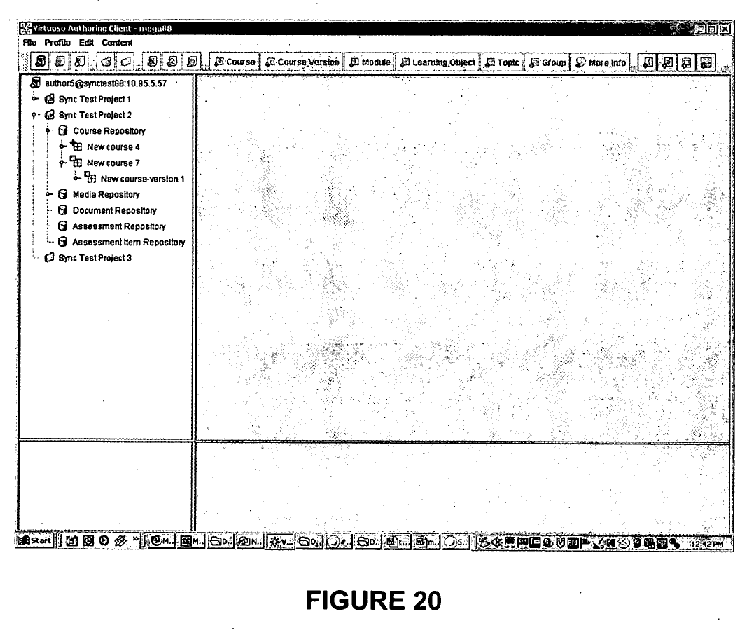

The screenshot of FIG. 20 is taken after synchronization. A cylinder on Course 7 indicates that User 2 now has all of the updated course materials. The screenshot of FIG. 20 illustrates how the system notifies User 2 that another user has checked-out certain content. In this case, the checkmark 275 on module 2 (“New module 2,” as illustrated) indicates that module 2 has been checked-out by another user. User 2 is free to check-out other materials, such as module 1 (a sibling of module 2), but User 2 preferably cannot check out New Course-version 1 or New Course 7, as they are parent objects. Thus, this screenshot illustrates how two authors can simultaneously work on different portions of the same course material. With reference to FIG. 21, collaboration can be enhanced by the use of a message pane 276 at the bottom of the screen. In one embodiment, the users can use the message pane 276 to send messages to one another concerning the course materials or other subjects (e.g., “Hey Jim, I noticed you're working on module 1. Please review the latest research at Internet site powerful.com/research to see if it is relevant.”). The message pane 276 can also display messages generated by the server 12.

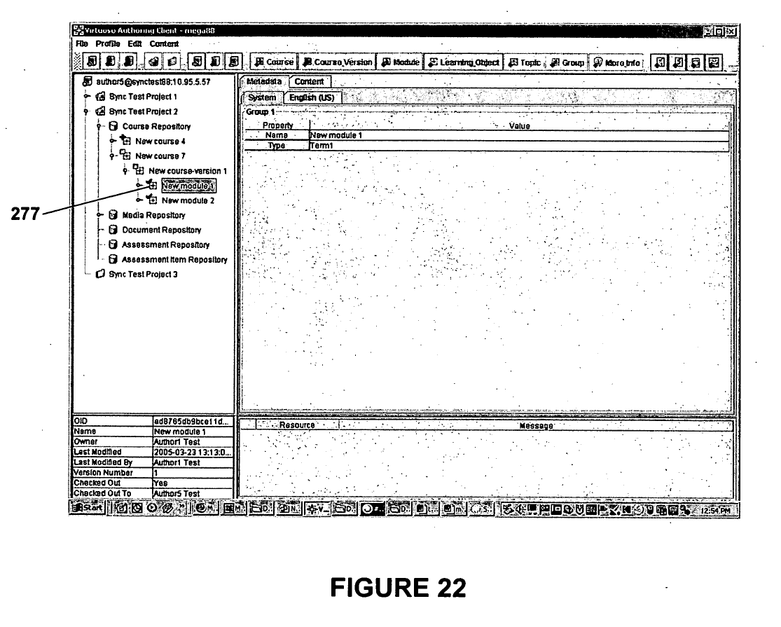

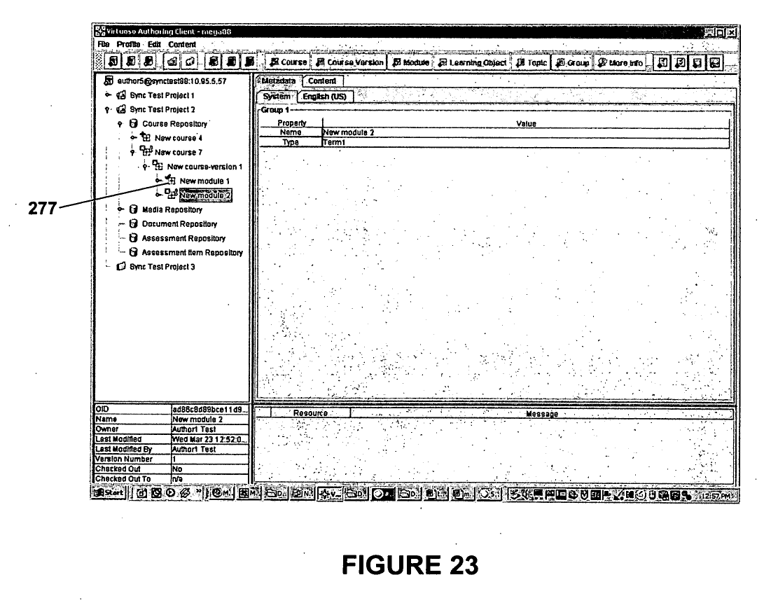

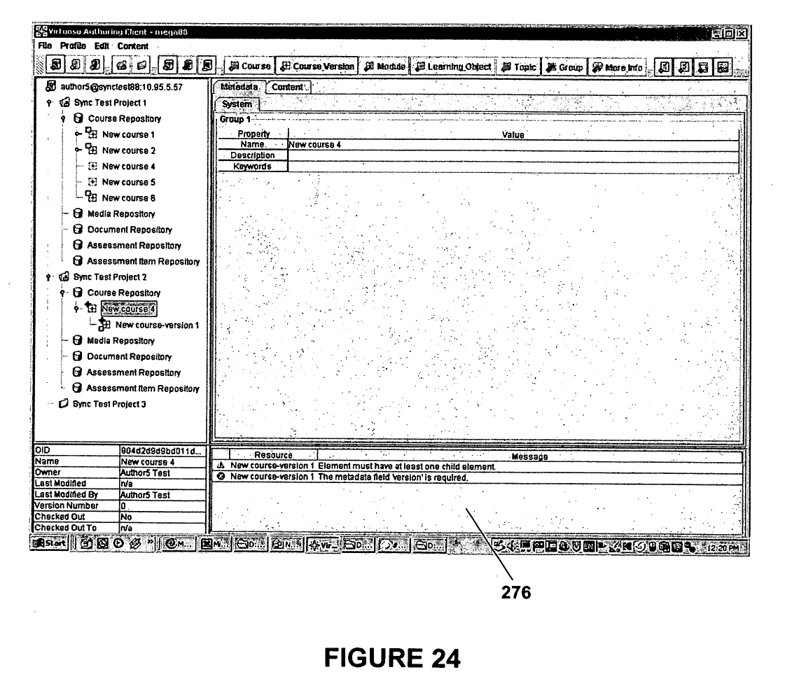

The screenshot of FIG. 22 is taken after User 2 checks out module 1. A checkmark 277 is now shown on module 1 in the object hierarchy. The screenshot of FIG. 23 is taken after User 1 checks-in module 2. The checkmark 275 (FIG. 21) on module 2 in the object hierarchy is now removed. There is still a checkmark 277 shown on module 1, which reflects the fact that User 2 has not yet checked-in module 1. The screenshot of FIG. 24 shows further usage of the message pane 276. In particular, this screenshot illustrates how the server 12 can send guidance or error messages to User 2. The message pane 276 can also be used by administrators for various messages, such as the addition of new metadata fields that need to be filled in.

Task Messaging

The system 10 may include a task messaging subsystem configured provide task-specific messages to authors as they prepare educational content. The task messaging subsystem can also be configured to deliver real-time work flow messages. These messages can relate to errors that the system detects in the unfinished content, or guidance and helpful hints on how to improve the content. Preferably, these messages are generated and delivered to the author's client dynamically during the process of content preparation, and not necessarily in response to synchronization tasks. In a preferred embodiment, the rules engine 20 (FIG. 1) includes a set of rules that govern the preparation and delivery of task-related messages. The rules engine 20 can be configured to continuously analyze these rules to detect possible errors in an author's content or aspects of the content that can be improved. The task messages can be sent to the client individually or in batches.

For example, the rules engine 20 can include a rule requiring that a course must have a chapter that is viewable by an instructor and hidden from the students (i.e., the chapter is “instructor's eyes only”). In such a case, if at a certain predetermined point during the development of the course no such chapter has been created, a real-time task notification will be delivered to one or more authors instructing them to create the instructor's eyes only chapter. As another example, the system 10 may notify a user to include information in a particular metadata field associated with an object (e.g., content item) during check-in. In yet another example, the rules engine 20 might notify one ore more authors that a particular content item at a specific level in a course outline violates a format rule requiring content items at that level to have a specific number of subservient content elements or child objects, or child objects of prescribed types. In another example, the rules engine 20 might notify one or more authors that a specific chapter violates a format rule requiring at least one sub-chapter comprising a case study. Skilled artisans will appreciate that a large number of different types of format rules are possible.

In some embodiments, the system 10 is configured to send real-time notification to one or more users (e.g., authors, administrators, super administrators) while excluding other users from receiving the notification. For example, if one or more users are working on a first course and one or more users are working on a second course, the system 10 may be configured to send real-time notification associated with the first course to the one or more users working on the first course only.

With further reference to the screen display of FIG. 24, the task-specific messages can be sent to the message pane 276 at the bottom of the screen. In the illustrated screen display, the rules engine 20 has generated two task messages for the user. The first message indicates that the new course-version 1 element must have at least one child element. The second message indicates that in the new course-version 1 the metadata field “version” is required. Thus, the task messaging subsystem can assist authors in correctly formatting their content.

For example, suppose an organization decides that all new courses in projects “Adult Ed” and “Prof Ed” need an instructor chapter, and that the instructor chapter must contain at least one content object “typed” (a metadata field) to address the racial sensitivities that the instructor must address during the course. It is not required that this task be completed initially during course development, but it must be completed before the course can be marked as being in the state “production” (a metadata field at the course level, added by this organization as part of their customized workflow). This rule is created and entered into the rules engine 20. When a new course is created in either “Adult Ed” or “Prof Ed,” the rules engine 20 coordinates with the task messaging system to alert all authors qualified to develop racial sensitivities content object (a metadata field added by this organization to the author objects in the learning management system). This new task shows up for all authors, in their authoring client 26, preferably in the task pane 276. When an author chooses to “take action” on the task, all other authors are preferably alerted. When the task is marked completed by the author, the task is preferably removed from the task pane 276 of all the other authors' clients 26.

Another example of the usage of the task pane 276 is as follows. Suppose an Author A creates a new learning object, and associates multiple “tasks” with it. Author A or perhaps another Author B can then make any of those tasks visible to other authors in their task panes 276, so that the first available author can execute against that task.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. It will be appreciated by those skilled in the art that various other omissions, additions and modifications may be made to the methods and systems described above without departing from the scope of the invention. For example, while systems and methods of preferred embodiments have been described in the context of authors, they may apply to administrators and super administrators as well. As an example to illustrate this point, an administrator may check-in or check-out a particular content object. All such modifications and changes are intended to fall within the scope of the invention, as defined by the appended claims.

We claim:

1. A system for authoring content for a distributed learning system, comprising:
one or more servers configured to store an educational course configured to be delivered electronically to students, the course having been developed by a plurality of authors; and
a synchronization module configured to detect a change in the course, and responsive to said change send messages to the authors informing them of the change.

2. The system of claim 1, wherein the synchronization module is configured to respond to said change by sending the messages to the authors substantially simultaneously.

3. The system of claim 1, wherein said messages inform the authors that the course has changed, but do not inform the authors of exactly what the change is.

4. The system of claim 3, wherein said messages identify an author who made the change.

5. The system of claim 3, wherein said messages identify where the change resides in a course outline.

6. The system of claim 3, wherein said messages indicate when the change was made.

7. The system of claim 3, wherein said messages include comments by an author who made the change.

8. The system of claim 3, wherein said messages include metadata describing the change.

9. The system of claim 1, wherein said messages inform the authors of a portion of the course containing the change.

10. The system of claim 1, further comprising a rules module and a set of format rules, the rules module configured to (1) analyze the course for violations of the format rules as the course is being created or modified by one of the authors, and (2) if one of the format rules is violated, inform said one author of the rule violation.

11. The system of claim 1, wherein the course is organized in accordance with a content object hierarchy, the course comprising a plurality of content objects, at least one of the content objects being stored in association with formatting data specifying the content object's location within the content object hierarchy, the formatting data also specifying an instructional strategy that dictates how the content object should be presented to a student on a client computer screen.

12. The system of claim 11, wherein the formatting data comprises metadata.

13. The system of claim 11, wherein most of the content objects are stored in association with formatting data specifying the content objects' locations within the content object hierarchy, the formatting data also specifying an instructional strategy that dictates how the content objects should be presented to a student on a client computer screen

14. A method for synchronizing content in a distributed learning system, comprising:
electronically storing within a storage an educational course that has been authored by a plurality of authors, the course configured to be delivered electronically to students;
determining that a change has occurred to the educational course; and
responsive to said determination, electronically informing one or more of the authors of the change.

15. The method of claim 14, wherein informing comprises rendering on client computers of the one or more authors visual indications that a change has occurred to the educational course.

16. The method of claim 14, wherein informing comprises sending a text message to the authors.

17. The method of claim 14, further comprising transmitting to the one or more authors either an updated version of the course or a course portion containing the change.

18. The method of claim 17, further comprising replacing a previous version of the course or the course portion with the updated version.

19. The method of claim 18, further comprising storing on the one or more servers both the previous version and the updated version.

20. The method of claim 14, further comprising:
receiving from one of the authors a synchronization request for at least a portion of the course; and
electronically transmitting a current version of the requested portion of the course to the requesting author.

21. The method of claim 14, wherein informing comprises:
rendering a hierarchical outline of the course on a client computer of one of the authors; and
rendering on the client computer a visual indication that a portion of the outline has been changed relative to a most recent version of the course that the client computer has downloaded from the one or more servers.

22. The method of claim 14, wherein determining comprises:
receiving a request from a client computer to determine whether at least a portion of the course on the client computer is out-of-sync with at least a portion of the course on the one or more servers;
running a diagnostic procedure to determine whether the course portion on the client computer is out-of-sync.

23. The method of claim 14, wherein the change comprises a deletion of at least a portion of the course.

24. The method of claim 14, wherein the course comprises a first portion authored by a first one of the authors and a second portion authored by a second one of the authors, the first portion including a read-only copy of a sub-portion of the second portion, wherein determining that a change has occurred to the course comprises determining that the sub-portion has been changed, and wherein informing comprises:
rendering a hierarchical outline of the course on a client computer of the first author; and
visually differentiating a representation of the sub-portion within the outline.

25. The method of claim 24, further comprising transmitting a read-only copy of an updated version of the sub-portion to the client computer.

26. The method of claim 14, wherein the course comprises a first portion authored by a first one of the authors and a second portion authored by a second one of the authors, the first portion including a link to a sub-portion of the second portion, wherein determining that a change has occurred to the course comprises determining that the sub-portion has been deleted, and wherein informing comprises:
rendering a hierarchical outline of the course on a client computer of the first author; and
visually differentiating a representation of the sub-portion within the outline.

27. The method of claim 14, wherein the course is organized in accordance with a content object hierarchy, the course comprising a plurality of content objects, at least one of the content objects being stored in association with formatting data specifying the content object's location within the content object hierarchy, the formatting data also specifying an instructional strategy that dictates how the content object should be presented to a student on a client computer screen.

28. The method of claim 27, wherein the formatting data comprises metadata.

29. The method of claim 27, wherein most of the content objects are stored in association with formatting data specifying the content objects' locations within the content object hierarchy, the formatting data also specifying an instructional strategy that dictates how the content objects should be presented to a student on a client computer screen.

30. A system for synchronizing content in a distributed learning system, comprising:
a means for storing an educational course configured to be delivered electronically to students, the course having been developed by a plurality of authors;
a means for detecting a change in the educational course; and
a means for informing at least one of said authors of the change.

31. The system of claim 30, wherein the course is organized in accordance with a content object hierarchy, the course comprising a plurality of content objects, most of the content objects being stored in association with metadata specifying the content objects' locations within the content object hierarchy, the formatting data also specifying an instructional strategy that dictates how the content objects should be presented to a student on a client computer screen.

32. An authoring system for an educational course configured to be delivered electronically to students, the course comprising a plurality of content objects organized in accordance with a content object hierarchy, the authoring system comprising a rules module employing a set of format rules governing presentation of the content objects within the content hierarchy, the rules module configured to (1) analyze the content objects for violations of the format rules as the content objects are being created by an author, and (2) if one of the format rules is violated, inform the author of the rule violation.

33. The system of claim 32, wherein at least one of the content objects is stored in association with formatting data specifying the content object's location within the content object hierarchy, the formatting data also specifying an instructional strategy that dictates how the content object should be presented to a student on a client computer screen.

34. The system of claim 41, wherein the formatting data comprises metadata.

35. The system of claim 41, wherein most of the content objects are stored in association with formatting data specifying the content objects' locations within the content object hierarchy, the formatting data also specifying an instructional strategy that dictates how the content objects should be presented to a student on a client computer screen.

36. A method of controlling an educational course configured to be delivered electronically to students, the course comprising a plurality of content objects organized in accordance with a content object hierarchy, the method comprising:
analyzing content objects for violations of format rules as the content objects are being created by an author, the format rules governing presentation of the content objects within the content object hierarchy;
detecting a violation of at least one of the format rules; and
informing the author about the rule violation.

37. The method of claim 36, wherein at least one of the content objects is stored in association with formatting data specifying the content object's location within the content object hierarchy, the formatting data also specifying an instructional strategy that dictates how the content object should be presented to a student on a client computer screen.

38. The method of claim 37, wherein the formatting data comprises metadata.

39. The method of claim 37, wherein most of the content objects are stored in association with formatting data specifying the content objects' locations within the content object hierarchy, the formatting data also specifying an instructional strategy that dictates how the content objects should be presented to a student on a client computer screen.

40. The method of claim 36, wherein the rule violation comprises an instance in which a content object at one level in the content object hierarchy violates a rule requiring the content object be supported by a certain number of content objects at an immediately lower level of the content object hierarchy.

41. A system for collaborative authorship of content for a distributed delivery system, comprising:
at least one server configured to store an educational course configured to be delivered electronically to students, the course comprising a plurality of content objects organized in accordance with a content object hierarchy, the course having been developed by a plurality of authors; and
a plurality of client computer systems configured to communicate with the server, each of the client computer systems comprising:
a display configured to show a hierarchical outline of the educational course;
a messaging module configured to send and receive course-related event messages to and from the server; and
a user interface module configured to update the display in accordance with course-related events,
wherein said server is configured to send course-related event messages to the client computer systems.

42. The system of claim 41, wherein the course-related events comprise instances in which an author has added a new content object to the course, modified an existing content object of the course, or deleted a content object from the course.

43. The system of claim 41, wherein the client computer systems are each configured to download a latest version of at least a portion of the course from the server in response to receiving a course-related event message.

44. The system of claim 41, wherein the display of each client computer system is configured to show one or more visual indications that content objects of the course have been modified or deleted.

45. The system of claim 41, wherein at least one of the content objects is stored in association with formatting data specifying the content object's location within the content object hierarchy, the formatting data also specifying an instructional strategy that dictates how the content object should be presented to a student on a client computer screen.

46. The system of claim 45, wherein the formatting data comprises metadata.

47. The system of claim 45, wherein most of the content objects are stored in association with formatting data specifying the content objects' locations within the content object hierarchy, the formatting data also specifying an instructional strategy that dictates how the content objects should be presented to a student on a client computer screen.

48. A method of regulating access to an educational course, comprising:
maintaining in storage an educational course configured to be delivered electronically to students, the course comprising a plurality of content objects organized in accordance with a content object hierarchy, the course having been developed by a plurality of authors;
receiving a request from a first author to check out a content object; and
notifying at least one other author that the content object has been checked out by the first author.

49. The method of claim 48, wherein notifying comprises:
rendering a hierarchical outline of the course on a client computer display of the other author; and
visually differentiating the content object on the client computer display of the other author.

50. The method of claim 48, further comprising, after the receiving step and before the notifying step, transmitting the content object to a client computer of the first author.

51. The method of claim 48, wherein the content object is a first content object, the method further comprising:
preventing the other author from retrieving content objects that are subservient to the first content object in the content object hierarchy; and
preventing the other author from retrieving content objects that the first content object is subservient to in the content object hierarchy.

52. The method of claim 51, further comprising permitting the other author to retrieve a content object that, in the content object hierarchy, is (1) subservient to a content object to which the first content object is subservient and (2) not subservient to the first content object.

53. The method of claim 51, wherein at least one of the content objects is stored in association with formatting data specifying the content object's location within the content object hierarchy, the formatting data also specifying an instructional strategy that dictates how the content object should be presented to a student on a client computer screen.

54. The method of claim 53, wherein the formatting data comprises metadata.

55. The method of claim 53, wherein most of the content objects are stored in association with formatting data specifying the content objects' locations within the content object hierarchy, the formatting data also specifying an instructional strategy that dictates how the content objects should be presented to a student on a client computer screen.

56. A method of modifying educational course material while disconnected from a distributed learning system, comprising:
connecting a client computer to a storage, the storage maintaining an educational course configured to be delivered electronically to students, the course comprising a plurality of content objects organized in accordance with a content object hierarchy, the course having been developed by a plurality of authors;
checking out a content object from the storage;
disconnecting the client computer from the storage after checking out the content object;
modifying the content object on the client computer while the client computer is disconnected from the storage; and
reconnecting the client computer to the storage after modifying the content object.

57. The method of claim 56, further comprising transmitting the modified content object from the client computer to the storage after reconnecting.

58. The method of claim 56, wherein at least one of the content objects is stored in association with formatting data specifying the content object's location within the content object hierarchy, the formatting data also specifying an instructional strategy that dictates how the content object should be presented to a student on a client computer screen.

59. The method of claim 58, wherein the formatting data comprises metadata.

60. The method of claim 58, wherein most of the content objects are stored in association with formatting data specifying the content objects' locations within the content object hierarchy, the formatting data also specifying an instructional strategy that dictates how the content objects should be presented to a student on a client computer screen.
